(19) United States
(12) Patent Application Publication
(10) Pub. No.: US 2025/0011562 A1
(43) Pub. Date: Jan. 9, 2025

(54) AQUEOUS PROCESS FOR PREPARING POLYAMIC ACIDS AND POLYAMIC ACID RELATED GEL MATERIALS

(71) Applicant: Aspen Aerogels, Inc., Northborough, MA (US)

(72) Inventors: Nicholas Leventis, Worcester, MA (US); Redouane Begag, Hudson, MA (US); Rushi Soni, Shrewsbury, MA (US); Joshua Bartels, Northborough, MA (US); Hooman Yaghoobnejad Asl, Hudson, MA (US)

(73) Assignee: Aspen Aerogels, Inc., Northborough, MA (US)

(21) Appl. No.: 18/883,579

(22) Filed: Sep. 12, 2024

Related U.S. Application Data
(63) Continuation of application No. PCT/US2023/016821, filed on Mar. 30, 2023.
(60) Provisional application No. 63/352,571, filed on Jun. 15, 2022.

(51) Int. Cl. C08J 9/28; C08G 73/10; C08J 3/075; C08K 3/04

(52) U.S. Cl. CPC C08J 9/28; C08G 73/1028; C08G 73/1067; C08J 3/075; C08K 3/04; C08J 2201/0504; C08J 2203/02; C08J 2203/08; C08J 2205/026; C08J 2379/08

(57) ABSTRACT

The present disclosure is directed to methods of forming polyamic acid, polyamic acid metal salt, and polyimide gels under aqueous conditions, the methods utilizing water-soluble carbonate or bicarbonate salts. These gels may be converted to aerogels or xerogels, which may further be converted to carbon aerogels or xerogels. Such carbon aerogels or xerogels have the same physical properties as carbon aerogels or xerogels prepared from polyimide aerogels obtained according to conventional methods, i.e., organic solvent-based methods.

### CROSS REFERENCES TO RELATED APPLICATIONS

This application claims priority to and the benefit of U.S. Provisional Patent Application No. 63/352,571, filed Jun. 15, 2022, entitled “Aqueous Process For Preparing Polyamic Acids and Polyamic Acid Related Gel Materials” which is herein incorporated by reference in its entirety.

### TECHNICAL FIELD

The present disclosure relates generally to aqueous processes for preparation of aqueous solutions of salts of polyamic acids and to methods for converting such materials to porous polyamic acids, polyimides, and corresponding porous carbon materials.

### BACKGROUND

Aerogels are solid materials that include a porous network of interconnected micro-, meso-, and macro-sized pores. Depending on precursor materials used and processing undertaken, the pores of an aerogel can frequently account for over 90% of the volume. Aerogels are generally prepared by removing the solvent from a wet gel (a solid network prepared through a sol-gel process that contains a solvent) in a manner such that minimal or no contraction of the wet gel can be brought by capillary forces at its pore walls. Methods of solvent removal include, but are not limited to, supercritical drying (or drying using supercritical fluids, such that a low surface tension supercritical fluid replaces the high surface tension gelation solvent within the gel), exchange of solvent with supercritical fluid, exchange of solvent with fluid that is subsequently transformed to the supercritical state, sub- or near-critical drying, and sublimating a frozen solvent in a freeze-drying process. See for example, PCT Patent Application Publication No. WO2016127084A1. It should be noted that when drying in ambient conditions, gel contraction may take place with solvent evaporation, and a xerogel can form. Therefore, aerogel preparation through a sol-gel process (or optionally, an analogous process) typically proceeds in the following series of steps: dissolution of a monomer, or a mixture of monomers or a gel precursor in a solvent, addition of a catalyst or reagent that induces or promotes reaction of the monomer or monomers or gel precursor, formation of a reaction mixture, formation of the wet gel (may involve additional heating or cooling steps), and solvent removal by a supercritical drying technique or any other method that removes solvent from the gel without causing contraction or pore collapse.

Aerogels can be formed of inorganic materials, organic materials, or mixtures thereof. When formed of organic materials, the organic aerogel may be carbonizable (e.g., by pyrolysis at an elevated temperature under inert atmosphere) to form carbon aerogels, which can have properties (e.g., pore volume, pore size distribution, morphology, etc.) that differ from or overlap with the properties of the corresponding organic material, depending on the precursor materials and methodologies used. Examples of organic materials that can be carbonized include but are not limited to phenol-aldehyde polymers that include resorcinol-formaldehyde (RF) and phloroglucinol-furfuraldehyde (PF); polyolefins including polyacrylonitrile (PAN); selected polyimides (PI); polyurethanes (PU); polyureas (PUA); polyamides (PA); polydicyclopentadiene; precursors or polymeric derivatives of any thereof; and combinations thereof.

Recently, there have been efforts devoted to the development and characterization of carbon aerogels, xerogels and ambigels as electrode materials with improved performance for applications in energy storage devices, such as lithium-ion batteries (LIBs). Consequently, there is a demand for the corresponding organic aerogels. Such organic aerogels are generally prepared in organic solvents. For example, polyimide aerogels are generally prepared by allowing a diamine and a tetracarboxylic dianhydride to react in an organic solvent, followed by dehydrating the resulting polymeric primary product of the reaction, a polyamic acid, to form a polyimide gel. For economic, safety, and environmental reasons, it would be desirable to carry out formation and gelation of such polyamic acid-based gel materials using a “green” chemical process (i.e., using environmentally more benign alternatives to the traditional organic solvents and/or organic reagents).

### SUMMARY

The present technology is generally directed to methods of forming polyamic acids and related gel materials (e.g., polyimide wet gels, aerogels, xerogels and ambigels) while (a) minimizing or eliminating the use of harmful organic solvents, and (b) minimizing the use of organic reagents. Specifically, the present technology is directed to forming polyamic acid and polyimide gels in water using a water-soluble carbonate or bicarbonate salt for solubilization of the polyamic acid. Optionally, the gels thus formed may subsequently be converted to polyamic acid aerogels, polyimide gels and aerogels, and the corresponding carbon aerogels, xerogels, and/or other gel materials.

The disclosed methods generally comprise preparing an aqueous solution of a polyamic acid salt from the reaction of a water-soluble diamine and a tetracarboxylic acid dianhydride in the presence of a water-soluble carbonate or bicarbonate salt. Alternatively, an aqueous solution of a polyamic acid salt may be prepared from a preformed polyamic acid by dissolving the acid in water in the presence of a water-soluble carbonate or bicarbonate salt. Surprisingly, according to the present disclosure, it was found that such water-soluble carbonate or bicarbonate salts (including, but not limited to, carbonates and bicarbonates of certain alkali metals, ammonia, and guanidine) resulted in the formation of the corresponding polyamic acid salt (also referred to as a salt of a polyamic acid, or simply as a polyamate salt) and further, upon imidization, the resulting polyimides were mechanically robust and often optically transparent. Particularly, the resulting polyimides possessed physical properties substantially similar to those of polyimides prepared by conventional (i.e., organic solvent based) methods. In contrast, using amine bases with reduced nucleophilicity (e.g., triethylamine) under the same conditions typically resulted in wet gels, which are generally translucent or opaque, and weaker with respect to their physical strength.

Accordingly, in one aspect is provided a method of preparing an aqueous solution of a polyamic acid salt. In a general non-limiting aspect, the method comprises combining in water a water-soluble diamine, a water-soluble carbonate or bicarbonate salt, and a tetracarboxylic acid dianhydride, and allowing the components to react, providing the solution of the polyamic acid salt. The order of addition of each of the reaction components (i.e., water-soluble diamine, water-soluble carbonate or bicarbonate salt, and tetracarboxylic acid dianhydride) may vary.

In some aspects, combining the reaction components comprises dissolving the water-soluble diamine in water to form an aqueous diamine solution; adding the water-soluble carbonate or bicarbonate salt to the aqueous diamine solution; adding the tetracarboxylic acid dianhydride to the aqueous solution of the diamine and the water-soluble carbonate or bicarbonate salt to form a solution; and stirring the solution for a period of time in a range from about 1 hour to about 4 days at a temperature in a range from about 4-° C. to about 60° C.

In some aspects, the water-soluble carbonate or bicarbonate salt comprises lithium, sodium, potassium, ammonium, alkylammonium, guanidinium, or combinations thereof.

In some aspects, the water-soluble carbonate or bicarbonate salt is selected from the group consisting of lithium carbonate, lithium bicarbonate, sodium carbonate, sodium bicarbonate, potassium carbonate, potassium bicarbonate, and combinations thereof.

In some aspects, the water-soluble carbonate or bicarbonate salt is selected from the group consisting of guanidinium carbonate, ammonium carbonate, and ammonium bicarbonate. In some aspects, the water-soluble carbonate or bicarbonate salt is guanidinium carbonate.

In some aspects, the water-soluble carbonate or bicarbonate salt is a carbonate, and a molar ratio of the carbonate to the diamine is from about 1 to about 1.4.

In some aspects, the water-soluble carbonate or bicarbonate salt is a bicarbonate, and the molar ratio of the bicarbonate to the diamine is from about 2 to about 2.8.

In some aspects, a molar ratio of the tetracarboxylic acid dianhydride to the diamine is from about 0.9 to about 1.1.

In some aspects, the tetracarboxylic acid dianhydride is selected from the group consisting of pyromellitic dianhydride (PMDA), biphthalic dianhydride (BPDA), oxydiphthalic dianhydride (ODPA), benzophenone tetracarboxylic dianhydride (BTDA), ethylenediaminetetraacetic dianhydride (EDDA), 1,4,5,8-naphthalenetetracarboxylic dianhydride, and combinations thereof. In some aspects, the tetracarboxylic acid dianhydride is pyromellitic dianhydride (PMDA). In some aspects, the tetracarboxylic acid dianhydride is benzophenone tetracarboxylic dianhydride (BTDA).

In some aspects, the water-soluble diamine is a C2-C6 alkylene diamine, wherein one or more of the carbon atoms of the C2-C6 alkylene is optionally substituted with one or more alkyl groups. In some aspects, the C2-C6 alkylene diamine is selected from the group consisting of 1,3-diaminopropane, 1,4-diaminobutane, 1,5-diaminopentane, 1,6-diaminohexane and ethylenediamine.

In some aspects, the water-soluble diamine is 1,3-phenylenediamine, 4,4′-methylenedianiline, or a combination thereof. In some aspects, the water-soluble diamine is selected from the group consisting of 1,4-phenylenediamine, 1,3-phenylenediamine, and combinations thereof. In some aspects, the water-soluble diamine is 1,4-phenylenediamine. In some aspects, the water-soluble diamine is 1,3-phenylenediamine

In some aspects, a range of concentration of the polyamic acid salt in the aqueous solution is from about 0.01 to about 0.3 g/cm³, based on the weight of the polyamic acid.

In some aspects, a molar ratio of the tetracarboxylic acid dianhydride to the diamine is from about 0.9 to about 1.1.

In some aspects, the method further comprises adding an electroactive material to the aqueous solution of the polyamic acid salt. In some aspects, the electroactive material comprises carbon, graphite, silicon, tin, sulfur, Prussian blue, a lithium metal phosphate, a lithium mixed-metal phosphate, or a lithium metal fluorophosphate. In some aspects, the electroactive material comprises lithium iron phosphate, lithium manganese phosphate, lithium vanadium phosphate, a combination thereof, or one or more precursors of any thereof. In some aspects, the electroactive material is silicon. In some aspects, the electroactive material is lithium iron phosphate.

In some aspects, the method further comprises forming a polyamic acid aerogel, wherein forming the polyamic acid aerogel comprises: acidifying the polyamic acid salt solution to form a polyamic acid gel; and drying the polyamic acid gel to form the polyamic acid aerogel.

In some aspects, drying the polyamic acid gel comprises: optionally, washing or solvent exchanging the polyamic acid gel; and subjecting the optionally washed or solvent exchanged polyamic acid gel to elevated temperature conditions, lyophilizing the optionally washed or solvent exchanged polyamic acid gel, or contacting the optionally washed or solvent exchanged polyamic acid gel with supercritical fluid carbon dioxide.

In some aspects, the washing or solvent exchanging is performed with water, a C1 to C4 alcohol, acetone, acetonitrile, ether, tetrahydrofuran, toluene, liquid carbon dioxide, or a combination thereof.

In a yet further aspect is provided a polyamic acid aerogel prepared by the method disclosed herein.

In some aspects, the polyamic acid aerogel comprises a residual amount of the water-soluble carbonate or bicarbonate salt.

In some aspects, the method further comprises forming a polyimide aerogel, wherein forming the polyimide aerogel comprises: imidizing the polyamic acid salt to form a polyimide gel; and drying the polyimide gel to form the polyimide aerogel.

In some aspects, imidizing the polyamic acid salt comprises adding a gelation initiator to the aqueous solution of the polyamic acid salt to form a gelation mixture and allowing the gelation mixture to gel. In some aspects, the gelation initiator is a carboxylic acid anhydride. In some aspects, the gelation initiator is acetic anhydride.

In some aspects, drying the polyimide gel comprises: optionally, washing or solvent exchanging the polyimide gel; and subjecting the polyimide gel to elevated temperature conditions, lyophilizing the polyimide gel, or contacting the polyimide gel with supercritical fluid carbon dioxide.

In some aspects, the washing or solvent exchanging is performed with water, a C1 to C4 alcohol, acetone, acetonitrile, ether, tetrahydrofuran, toluene, liquid carbon dioxide, or a combination thereof.

In a further aspect is provided a polyimide aerogel prepared by the method disclosed herein.

In some aspects, the polyimide aerogel comprises a residual amount of the water-soluble carbonate or bicarbonate salt.

In some aspects, the method further comprises converting a polyamic acid aerogel and/or polyimide aerogel as disclosed herein to an isomorphic carbon aerogel, the converting comprising pyrolyzing the aerogel under inert atmosphere at a temperature of at least about 500° C.

In a further aspect is provided a carbon aerogel prepared by the method disclosed herein.

In some aspects, the carbon aerogel comprises an electroactive material.

In some aspects, the carbon aerogel has properties substantially similar to those of a carbon aerogel prepared by pyrolyzing a corresponding polyimide aerogel that has been prepared by a conventional, non-aqueous method.

In another aspect is provided a method of preparing an aqueous solution of a polyamic acid salt, the method comprising providing a suspension in water of a preformed polyamic acid, and adding to the suspension a water-soluble carbonate or a bicarbonate salt, wherein the water-soluble carbonate or a bicarbonate salt is added in an amount sufficient to fully dissolve the polyamic acid, forming the aqueous solution of the polyamic acid salt. Such aqueous solutions of the polyamic acid salt may be further processed according to any of the aspects described above.

The disclosure includes, without limitations, the following aspects.

Aspect 1: A method of preparing an aqueous solution of a salt of a polyamic acid, the method comprising: providing a polyamic acid; and combining in water the polyamic acid and a water-soluble carbonate or bicarbonate salt, thereby providing the solution of the salt of the polyamic acid.

Aspect 2: The method of Aspect 1, wherein the water-soluble carbonate or bicarbonate salt comprises lithium, sodium, potassium, ammonium, or guanidinium cations.

Aspect 3: The method of Aspect 1 or 2, wherein the water-soluble carbonate or bicarbonate salt is selected from the group consisting of lithium carbonate, lithium bicarbonate, sodium carbonate, sodium bicarbonate, potassium carbonate, potassium bicarbonate, ammonium carbonate, ammonium bicarbonate, guanidinium carbonate, and combinations thereof.

Aspect 4: A method of preparing an aqueous solution of a salt of a polyamic acid, the method comprising: combining in water a water-soluble diamine, a water-soluble carbonate or bicarbonate salt, and a tetracarboxylic acid dianhydride; and allowing the components to react, providing the solution of the salt of the polyamic acid.

Aspect 5: The method of Aspect 4, wherein the combining comprises: dissolving a water-soluble diamine in water to form an aqueous diamine solution; adding the water-soluble carbonate or bicarbonate salt to the aqueous diamine solution; adding a tetracarboxylic acid dianhydride to the aqueous solution of the diamine and the water-soluble carbonate or bicarbonate salt to form a solution; and stirring the solution for a period of time in a range from about 1 hour to about 4 days at a temperature in a range from about 4 to about 60° C.

Aspect 6: The method of Aspect 4, wherein the combining comprises: dissolving a water-soluble diamine in water to form an aqueous diamine solution; adding a tetracarboxylic acid dianhydride to the aqueous diamine solution to form a suspension; stirring the suspension for a period of time in a range from about 1 hour to about 4 days at a temperature in a range from about 4 to about 60° C.; adding the water-soluble carbonate or bicarbonate salt to the suspension; and stirring the suspension for a period of time in a range from about 1 hour to about 4 days at a temperature in a range from about 4 to about 60° C. to provide the aqueous solution of the salt of the polyamic acid.

Aspect 7: The method of Aspect 4, wherein the combining comprises: adding to water, simultaneously or in rapid succession, a water-soluble diamine, a tetracarboxylic acid dianhydride, and the water-soluble carbonate or bicarbonate salt; and stirring the resulting mixture for a period of time in a range from about 1 hour to about 4 days at a temperature in a range from about 4 to about 60° C. to provide the aqueous solution of the polyamic acid salt.

Aspect 8: The method of any one of Aspects 4-7, wherein the water-soluble carbonate or bicarbonate salt comprises lithium, sodium, potassium, ammonium, or guanidinium cations.

Aspect 9: The method of any one of Aspects 4-8, wherein the water-soluble carbonate or bicarbonate salt is selected from the group consisting of lithium carbonate, lithium bicarbonate, sodium carbonate, sodium bicarbonate, potassium carbonate, potassium bicarbonate, ammonium carbonate, ammonium bicarbonate, guanidinium carbonate, and combinations thereof.

Aspect 10: The method of any one of Aspects 4-9, wherein: the water-soluble carbonate or bicarbonate salt is a carbonate, and a molar ratio of the water-soluble carbonate salt to the diamine is from about 1 to about 1.4; or the water-soluble carbonate or bicarbonate salt is a bicarbonate, and a molar ratio of the water-soluble bicarbonate salt to the diamine is from about 2 to about 2.8.

Aspect 11: The method of any one of Aspects 4-10, wherein a molar ratio of the tetracarboxylic acid dianhydride to the diamine is from about 0.9 to about 1.1.

Aspect 12: The method of any one of Aspects 4-11, wherein the tetracarboxylic acid dianhydride is selected from the group consisting of biphthalic dianhydride (BPDA), benzophenone tetracarboxylic dianhydride (BTDA), oxydiphthalic dianhydride (ODPA), napthanyl tetracarboxylic dianhydride, perylene tetracarboxylic dianhydride, and pyromellitic dianhydride (PMDA).

Aspect 13: The method of any one of Aspects 4-12, wherein the diamine is 1,3-phenylenediamine, 1,4-phenylenediamine, or a combination thereof.

Aspect 14: The method of any one of Aspects 4-13, wherein the diamine is 1,4-phenylenediamine.

Aspect 15: The method of any one of Aspects 4-14, wherein a range of concentration of the polyamic acid salt in the aqueous solution is from about 0.01 to about 0.3 g/cm³, based on the weight of the polyamic acid.

Aspect 16: The method of any one of Aspects 1-15, wherein the water-soluble carbonate or bicarbonate salt is guanidinium carbonate, and wherein the solution of the salt of the polyamic acid exhibits thixotropic behavior.

Aspect 17: The method of any one of Aspects 1-16, further comprising adding an electroactive material to the aqueous solution of the polyamic acid salt.

Aspect 18: The method of Aspect 17, wherein the electroactive material comprises carbon, graphite, silicon, sulfur, Prussian blue, lithium iron phosphate, a combination thereof, or a one or more precursors of any thereof.

Aspect 19: The method of any one of Aspects 1-18, further comprising forming a polyamic acid aerogel, wherein forming the polyamic acid aerogel comprises: acidifying the polyamic acid salt solution to form a polyamic acid wet gel; and drying the polyamic acid wet gel to form the polyamic acid aerogel.

Aspect 20: The method of Aspect 19, wherein drying the polyamic acid wet gel comprises: optionally, washing or solvent exchanging the polyamic acid wet gel; and subjecting the polyamic acid wet gel to elevated temperature conditions, lyophilizing the polyamic acid wet gel, or contacting the polyamic acid wet gel with supercritical fluid carbon dioxide.

Aspect 21: The method of Aspect 19 or 20, further comprising converting the polyamic acid aerogel to an isomorphic carbon aerogel, the converting comprising pyrolyzing the polyamic acid aerogel material under inert atmosphere at a temperature of at least about 650° C.

Aspect 22: The method of any one of Aspects 1-18, further comprising forming a polyimide aerogel, wherein forming the polyimide aerogel comprises: imidizing the polyamic acid salt to form a polyimide wet gel; and drying the polyimide wet gel to form the polyimide aerogel.

Aspect 23: The method of Aspect 22, wherein imidizing the polyamic acid salt comprises adding a gelation initiator to the aqueous solution of the polyamic acid salt to form a gelation mixture and allowing the gelation mixture to gel.

Aspect 24: The method of Aspect 23, wherein the gelation initiator is acetic anhydride.

Aspect 25: The method of any one of Aspects 22-24, wherein drying the polyimide wet gel comprises: optionally, washing or solvent exchanging the polyimide wet gel; and subjecting the polyimide wet gel to elevated temperature conditions, lyophilizing the polyimide wet gel, or contacting the polyimide wet gel with supercritical fluid carbon dioxide.

Aspect 26: The method of Aspect 20 or 25, wherein the washing or solvent exchanging is performed with water, a C1 to C4 alcohol, acetone, acetonitrile, ether, tetrahydrofuran, toluene, liquid carbon dioxide, or a combination thereof.

Aspect 27: The method of any one of Aspects 22-26, further comprising converting the polyimide aerogel to an isomorphic carbon aerogel, the converting comprising pyrolyzing the polyimide aerogel under inert atmosphere at a temperature of at least about 650° C.

Aspect 28: A polyamic acid salt prepared by the method of any one of Aspects 1-18.

Aspect 29: A polyamic acid aerogel prepared by the method of Aspect 19 or 20.

Aspect 30: A polyimide aerogel prepared by the method of any one of Aspects 22-26.

Aspect 31: The polyamic acid aerogel of Aspect 29, comprising a residual amount of the water-soluble carbonate or bicarbonate salt.

Aspect 32: The polyamide acid aerogel of Aspect 30, comprising a residual amount of the water-soluble carbonate or bicarbonate salt.

Aspect 33: A carbon aerogel prepared by the method of Aspect 21 or 27.

### BRIEF DESCRIPTION OF THE DRAWINGS

In order to provide an understanding of aspects of the technology, reference is made to the appended drawings, which are not necessarily drawn to scale. The drawings are exemplary only and should not be construed as limiting the technology. The disclosure described herein is illustrated by way of example and not by way of limitation in the accompanying drawings.

FIG. 1A is a solid-state nitrogen-15 nuclear magnetic resonance (NMR) spectrum of an organogel according to a non-limiting aspect of the disclosure.

FIG. 1B is a solid-state nitrogen-15 NMR spectrum of an organogel according to a non-limiting aspect of the disclosure

FIG. 2 is a photograph of a thin film cast on an aluminum sheet according to a non-limiting aspect of the disclosure.

FIG. 3 is a table of material characterization data for aerogels according to a non-limiting aspect of the disclosure.

FIG. 4 is a table of material characterization data for aerogels according to a non-limiting aspect of the disclosure.

FIG. 5A is a solid-state nitrogen-15 NMR spectrum of an organogel according to a non-limiting aspect of the disclosure.

FIG. 5B is a solid-state nitrogen-15 NMR spectrum of an organogel according to a non-limiting aspect of the disclosure.

FIG. 6 is a table of material characterization data for aerogels according to a non-limiting aspect of the disclosure.

FIG. 7 is a scanning electron microscopy (SEM) photomicrograph of a carbonized sample of a polyimide according to a non-limiting aspect of the disclosure.

FIG. 8 is a graphical depiction of oscillation stress versus storage modulus (G′) and loss modulus (G″) for various aqueous guanidinium polyamate solutions according to non-limiting aspects of the disclosure.

FIG. 9 is a graphical depiction of temperature versus yield stress for guanidinium polyamate solutions according to non-limiting aspects of the disclosure.

FIG. 10 is a graphical depiction of time versus oscillatory viscoelastic response as measured by tan(d) for an aqueous guanidinium polyamate solution according to a non-limiting aspect of the disclosure.

FIG. 11 is a graphical depiction of shear rate versus viscosity for various aqueous polyamate solutions according to non-limiting aspects of the disclosure.

FIG. 12 is a series of gel permeation chromatograms (GPCs) for various aqueous polyamate solutions according to non-limiting aspects of the disclosure.

FIG. 13 is a graphical depiction of viscosity versus GPC molecular weight for various aqueous polyamate solutions according to non-limiting aspects of the disclosure.

### DETAILED DESCRIPTION

Before describing several example aspects of the technology, it is to be understood that the technology is not limited to the details of construction or process steps set forth in the following description. The technology is capable of other aspects and of being practiced or being carried out in various ways. In general, the technology is directed to methods of forming polyamic acid gels and polyimide gels without the use of harmful organic solvents.

In one aspect, the methods generally comprise providing a polyamic acid, and combining in water the polyamic acid and a water-soluble carbonate or bicarbonate salt, thereby providing the solution of the salt of the polyamic acid. In other aspects, the methods generally comprise preparing a polyamic acid salt in situ. In such aspects, the methods generally comprise combining in water a water-soluble diamine, a water-soluble carbonate or a bicarbonate salt, and a tetracarboxylic acid dianhydride; and allowing the components to react, providing a solution of a polyamic acid salt. In some aspects, the methods further comprise converting the polyamic acid salt to a polyamic acid wet gel or aerogel, a polyimide wet gel or aerogel, or a corresponding carbon aerogel.

The disclosed methods are economically preferable to the conventional methods of preparing polyimide and polyamic acid gel materials (e.g., expensive organic solvents are avoided, and disposal costs are minimized) and “green” (i.e., beneficial from an environmental standpoint, as potentially toxic organic solvents and reagents are avoided or minimized, and production of toxic byproducts is minimized or eliminated), and are advantageous in potentially reducing the overall number of operations which must be performed to provide carbon gel materials.

The disclosed methods generally rely on the use of water-soluble carbonate or bicarbonate salts, including but not limited to alkali metal, ammonium, or guanidinium carbonates or bicarbonates, to neutralize the polyamic acid as it is formed, and provide the charge-compensating cation of the resulting polyamate salt. Without wishing to be bound by theory, it is believed that carbonate and bicarbonate salts in particular are advantageous in that the roles of the neutralizing species and of the cation provider are separated. Specifically, carbonate or bicarbonate reacts with the formed polyamic acid and is converted to CO₂, which departs from the reaction mixture as a gas, leaving behind the polyamic acid salt with the cation introduced with the carbonate or bicarbonate (e.g., an alkali metal, ammonium, or guanidinium cation). Further, such carbonate or bicarbonate possess buffering activity, maintaining the pH of the solution in a desired range.

Surprisingly, according to the present disclosure, it has been discovered that the solution of polyamic acid salt produced from reaction in water of 1,4-phenylenediamine and pyromellitic dianhydride reached higher viscosities at lower target density (Td) values in carbonate solutions as opposed to the viscosities achieved under similar conditions but using triethylamine (abbreviated as Et₃N or TEA), which generally is considered a non-nucleophilic amine base. Again, without wishing to be bound by any particular theory, it is believed that some residual and non-negligible nucleophilicity of Et₃N may be at least partially responsible for the lower viscosities obtained therewith, perhaps by diverting some of the PMDA to side reactions, thus limiting the length of the polyamic acid polymer. Another non-binding theory is that hydrolysis of Et₃N produces high concentrations of hydroxide ion, while in contrast, the buffering effect of the carbonate/bicarbonate/carbonic acid/CO₂ system maintains a lower pH value (lower concentration of hydroxide ions). Further, as noted above, protonation of bicarbonate and carbonate bases produce H₂CO₃ that decomposes to CO₂+H₂O, departing the reaction mixture completely as a gas and leaving behind the cation of the carbonate or bicarbonate as the charge balancing cation in the polyamic acid salt. Without wishing to be bound by any particular theory, it is believed that with no significant side reactions to interfere with the polymer growth (e.g., such as those which may occur with bases such as triethylamine), the polymerization appears to proceed to a relatively high molecular weight polymer. Desirably, lithium, sodium, potassium, ammonium, and guanidinium salts of polyamic acids, such as for example that produced from PDA and PMDA, are very water soluble, and the corresponding carbonate and bicarbonate salts are readily commercially available and inexpensive. Further surprising is that the polyimide gels prepared from such polyamic acids by chemical imidization under aqueous conditions appear physically similar (transparency, color, texture) to corresponding polyimide gels obtained from the conventional organic solvent process (e.g., in organic solvents like DMAC). Specifically, the gels were transparent, with a pale yellow to amber color, and had a plastic feel.

Further surprising is that it has been discovered according to the present disclosure that certain solutions of polyamic acid salts produced from reaction in water of a polyamic acid with guanidium carbonate, or certain solutions of polyamic acid salts produced from reaction in water of certain diamines, tetracarboxylic dianhydrides, and guanidium carbonate, exhibit thixotropic behavior. Thixotropy is a time-dependent shear thinning property. Specifically, certain gels or fluids which are viscous under static conditions become less viscous (e.g., flow) when subject to certain stresses (for example, when shaken, agitated, or shear-stressed). They then take a fixed time to return to a more viscous state when stress is removed. Some thixotropic fluids return to a gel state almost instantly, while others take much longer to return to a solid or nearly solid state. Thixotropic behavior is preferred for processing of certain materials at high flow rates (i.e., shear rates). Such flow behavior is applicable to three-dimensional (3D) printing, where a viscous solution will flow through an injection needle with a small force that creates a high shear situation inside the needle, but then the solution will regain its high viscosity almost immediately after it exits the needle to form a solid structure.

Accordingly, provided herein are methods of preparing polyamic acid salt solutions, polyamic acid gels, and polyimide gels under aqueous conditions. Further provided are methods for converting the polyamic acids to polyimides under aqueous conditions, and for converting polyamic acid, and polyimide gel materials to the corresponding carbon gel materials. Each of the various methods are described further herein below.

### Definitions

With respect to the terms used in this disclosure, the following definitions are provided. This application will use the following terms as defined below unless the context of the text in which the term appears requires a different meaning.

The articles “a” and “an” are used herein to refer to one or to more than one (i.e., to at least one) of the grammatical object of the article. The term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, the terms “framework” or “framework structure” refer to the network of interconnected oligomers, polymers, or colloidal particles that form the solid structure of a gel or an aerogel. The polymers or particles that make up the framework structures typically have a diameter of about 100 angstroms. However, framework structures of the present disclosure can also include networks of interconnected oligomers, polymers, or colloidal particles of all diameter sizes that form the solid structure within in a gel or aerogel.

As used herein, the term “aerogel” refers to a solid object, irrespective of shape or size, comprising a framework of interconnected solid structures, with a corresponding network of interconnected pores integrated within the framework, and containing gases such as air as a dispersed interstitial medium. As such, and irrespective of the drying method used, aerogels are open non-fluid colloidal or polymer networks that are expanded throughout their whole volume by a gas and are formed by the removal of all swelling agents (e.g., solvents) from a corresponding wet gel without volume reduction or compaction. Reference to an “aerogel” herein includes any open-celled porous materials which can be categorized as aerogels, xerogels, cryogels, ambigels, microporous materials, and the like, regardless of material (e.g., polyimide, polyamic acid, or carbon), unless otherwise stated.

Generally, aerogels possess one or more of the following physical and structural properties: (a) an average pore diameter ranging from about 2 nm to about 100 nm; (b) a porosity of about 60% or more; (c) a specific surface area of about 1, about 10, or about 20, to about 100 or about 1000 m²/g. Typically, such properties are determined using nitrogen sorption porosimetry testing and/or helium pycnometry. It can be understood that the inclusion of additives, such as a reinforcement material or an electrochemically active species, for example, silicon or lithium iron phosphate may decrease porosity and the specific surface area of the resulting aerogel composite. Densification may also decrease porosity of the resulting aerogel composite.

In some aspects, a gel material may be referred to specifically as a xerogel. As used herein, the term “xerogel” refers to a type of aerogel comprising an open, non-fluid colloidal or polymer networks that is formed by the removal of all swelling agents from a corresponding wet gel without any precautions taken to avoid substantial volume reduction or to retard compaction. A xerogel generally comprises a compact structure. Xerogels suffer substantial volume reduction during ambient pressure drying and generally have a porosity of about 40% or less.

As used herein, the term “gelation” or “gel transition” refers to the formation of a wet gel from a polymer system, e.g., a polyimide, or polyamic acid as described herein. At a point during the reactions described herein with respect to gelation, which is defined as the “gel point,” the sol loses fluidity. In the present context, gelation proceeds from an initial sol state (e.g., a solution of a salt of a polyamic acid), through a highly viscous disperse state, until the disperse state solidifies and the sol gels (the gel point), yielding a wet gel (e.g., polyimide or polyamic acid gel). Notably, such definition of gelation and gel point is simplified and does not take into account the potential for fluidity under stress, such as the thixotropic behavior of certain gels as described herein.

The amount of time it takes for the polymer solution (e.g., an aqueous solution of a salt of a polyamic acid) to transform into a gel in a form that can no longer flow is referred to as the “phenomenological gelation time.” Formally, gelation time is measured using rheology. At the gel point, the elastic property of the solid gel starts dominating over the viscous properties of the fluid sol. The formal gelation time is near the time at which the real and imaginary components of the complex modulus of the gelling sol cross. The two moduli are monitored as a function of time using a rheometer. Time starts counting from the moment the last component of the sol is added to the solution. See, for example, discussions of gelation in H. H. Winter “Can the Gel Point of a Cross-linking Polymer Be Detected by the G′-G″ Crossover?” Polym. Eng. Sci., 1987, 27, 1698-1702; S.-Y. Kim, D.-G. Choi and S.-M. Yang “Rheological analysis of the gelation behavior of tetraethylorthosilane/vinyltriethoxysilane hybrid solutions” Korean J. Chem. Eng., 2002, 19, 190-196; and M. Muthukumar “Screening effect on viscoelasticity near the gel point” Macromolecules, 1989, 22, 4656-4658.

As used herein, the term “wet gel” refers to a gel in which the mobile interstitial phase within the network of interconnected pores is primarily comprised of a liquid phase such as a conventional solvent or water, liquefied gases such as liquid carbon dioxide, or a combination thereof. Aerogels typically require the initial production of a wet gel, followed by processing and extraction to replace the mobile interstitial liquid phase in the gel with air or another gas. Examples of wet gels include, but are not limited to: alcogels, hydrogels, ketogels, carbonogels, and any other wet gels known to those in the art.

As used herein, reference to a “conventional” or “organic solvent-based” method of forming a polyimide gel material refers to a method in which a polyamic acid solution is prepared in an organic solvent from condensation of a diamine and a tetracarboxylic acid dianhydride, wherein the polyamic acid is subsequently dehydrated to form a polyimide gel. See, for example, U.S. Pat. Nos. 7,071,287 and 7,074,880 to Rhine et al., and U.S. Patent Application Publication No. 2020/0269207 to Zafiropoulos, et al.

The term “alkyl” as used herein refers to a straight chain or branched, saturated hydrocarbon group generally having from 1 to 20 carbon atoms (i.e., C1 to C20). Representative alkyl groups include, but are not limited to, methyl, ethyl, n-propyl, n-butyl, n-pentyl, and n-hexyl; while branched alkyl groups include, but are not limited to, isopropyl, sec-butyl, isobutyl, tert-butyl, isopentyl, and neopentyl. An alkyl group can be unsubstituted or substituted.

The term “alkenyl” as used herein refers to a hydrocarbon group generally having from 1 to 20 carbon atoms (i.e., C1 to C20), and having at least one site of unsaturation, i.e., a carbon-carbon double bond. Examples include, but are not limited to: ethylene or vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, and the like. An alkenyl group can be unsubstituted or substituted.

The term “substantially” as used herein, unless otherwise indicated, means to a great extent, for example, greater than about 95%, greater than about 99%, greater than about 99.9%, greater than 99.99%, or even 100% of a referenced characteristic, quantity, etc. as pertains to the particular context (e.g., substantially pure, substantially the same, and the like).

### Methods of Forming Polyimide, Polyamic Acid, Polyamic Acid Metal Salt, and Carbon Aerogels

The methods disclosed herein generally utilize polyamic acid and polyimide wet gels, which may be prepared without the use of organic solvents, and without use of organic bases (e.g., amines). Reference herein to preparation of polyamic acid and polyimide wet gels “without the use of organic bases” means that carbon-based alkaline materials such as amines are not utilized for the solubilization in water of a preformed polyamic acid nor for the in situ solubilization of polyamic acid as it is formed (i.e., by reaction between a diamine and tetracarboxylic dianhydride). For the avoidance of doubt, reference to an “organic base” does not include carbonate and bicarbonate salts, and further does not include carbonate and bicarbonate salts which comprise a nitrogen-containing cationic species (such as ammonium or guanidinium).

Reference herein to an aqueous solution means that the solution is substantially free of any organic solvent. The term “substantially free” as used herein in the context of organic solvents means that no organic solvent has been intentionally added, and no organic solvent is present beyond trace amounts. For example, in certain aspects, the aqueous solution can be characterized as having less than 1% by volume of organic solvent, or less than 0.1%, or less than 0.01%, or even 0% by volume of organic solvent. These water-based methods are advantageous in reducing material and waste disposal costs and reducing potential safety and environmental hazards.

### Preparing Polyamic Acid and Polyimide Gel Materials Under Aqueous Conditions

Provided herein are methods of preparing polyamic acid and polyimide gel materials under aqueous conditions. The methods generally comprise preparing an aqueous solution of a polyamic acid salt without the use of organic bases, and subsequently converting the polyamic acid salt to a polyamic acid gel or aerogel material, a polyimide gel or aerogel material, or a corresponding carbon aerogel material. Each of these materials and the corresponding method(s) are described further herein below.

### Polyamic Acid and Polyamic Acid Salt

Provided herein are methods of preparing an aqueous solution of a polyamic acid salt. Polyamic acids are polymeric amides having repeat units comprising carboxylic acid groups, carboxamido groups, and aromatic or aliphatic moieties, which comprise the diamine and tetracarboxylic acid from which the polyamic acid is derived. A “repeat unit” as defined herein is a part of the polyamic acid (or corresponding polyimide) whose repetition would produce the complete polymer chain (except for the terminal amino groups or unreacted anhydride termini) by linking the repeat units together successively along the polymer chain. One of skill in the art will recognize that the polyamic acid repeat units result from partial condensation of tetracarboxylic acid dianhydride carboxyl groups with the amino groups of a diamine.

In one aspect, the method comprises providing a polyamic acid and combining in water the polyamic acid and a water-soluble carbonate or bicarbonate salt, thereby providing the solution of the salt of the polyamic acid. In such aspects, the polyamic acid is a preformed polyamic acid, either a purchased, commercially available material or a material prepared from a suitable diamine and tetracarboxylic anhydride according to conventional, known techniques (such as preparation in an organic solvent solution). Suitable preformed polyamic acids are as described herein below with respect to in situ synthesized polyamic acids. Suitable water-soluble carbonate or bicarbonate salts are described further herein below.

Alternatively, the polyamic acid may be prepared in situ. Accordingly, in another aspect the aqueous solution of the polyamic acid salt is prepared by reaction of a water-soluble diamine and a tetracarboxylic acid dianhydride in the presence of a water-soluble carbonate or bicarbonate salt. Generally, the diamine is allowed to react with the tetracarboxylic acid dianhydride in the presence of the said carbonate or bicarbonate salt to form the polyamic acid salt. Accordingly, the method comprises combining in water a water-soluble diamine, a water-soluble carbonate or bicarbonate salt, and a tetracarboxylic acid dianhydride; and allowing the components to react, providing the solution of the polyamic acid salt. The polyamic acid salt comprises anionic carboxylate groups which are charge compensated by the cations from the carbonate or bicarbonate salt, and the polyamic acid salt is soluble in water. Each of the components utilized in the method (e.g., water-soluble diamine, tetracarboxylic acid dianhydride, water-soluble carbonate or bicarbonate salt and the like) are described further herein below.

The order of addition of the various components may vary. For example, in some aspects, combining comprises dissolving a water-soluble diamine in water to form an aqueous diamine solution; adding the water-soluble carbonate or bicarbonate salt to the aqueous diamine solution; adding the tetracarboxylic acid dianhydride to the aqueous solution of the diamine and the water-soluble carbonate or bicarbonate salt to form a solution; and stirring the solution for a period of time in a range from about 1 hour to about 4 days at a temperature in a range from about 15 to about 60° C.

In some aspects, combining comprises dissolving the water-soluble diamine in water to form an aqueous diamine solution; adding the tetracarboxylic acid dianhydride to the aqueous diamine solution to form a suspension; stirring the suspension for a period of time in a range from about 1 minute to about 24 hours at a temperature in a range from about 15 to about 60° C.; adding a water-soluble salt carbonate or bicarbonate salt to the suspension; and stirring the suspension for a period of time in a range from about 1 hour to about 4 days at a temperature in a range from about 15 to about 60° C. to provide the aqueous solution of the polyamic acid salt.

In some aspects, combining comprises adding to water, simultaneously or in rapid succession, a water-soluble diamine, a tetracarboxylic acid dianhydride, and a water-soluble carbonate or bicarbonate salt; and stirring the resulting mixture for a period of time in a range from about 1 hour to about 4 days at a temperature in a range from about 15 to about 60° C. to provide the aqueous solution of the polyamic acid salt.

A non-limiting, generic reaction sequence is provided in Scheme 1. In some, the reactions occur generally according to Scheme 1, and the reagents and product have structures according to the formulae in Scheme 1.

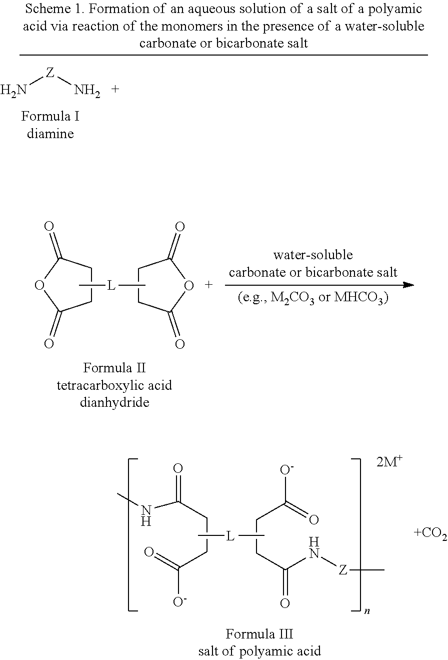

The diamine as disclosed herein is generally described as a “water-soluble diamine.” As used herein, the term “water-soluble diamine” means that the diamine has appreciable solubility in water, such that synthetically useful concentrations of the diamine can be obtained under the conditions utilized in the disclosed method. For example, diamines suitable for use in the disclosed methods may have a solubility in water at 20° C. of at least about 0.01 g per 100 mL, at least about 0.1 g per 100 mL, at least about 1 g per 100 mL, or at least about 10 g per 100 mL.

In some aspects, combinations of more than one diamine may be used. Combinations of diamines may be used in order to optimize the properties of the gel material. In some aspects, a single diamine is used.

With reference to Scheme I, the structure of the diamine may vary. In some aspects, the diamine has a structure according to Formula I, where Z is aliphatic (i.e., alkylene, alkenylene, alkynylene, or cycloalkylene) or aryl, each as described herein above. In some aspects, Z is alkylene, such as C2 to C12 alkylene or C2 to C6 alkylene. In some aspects, the diamine is a C2 to C6 alkane diamine, such as, but not limited to, 1,3-diaminopropane, 1,4-diaminobutane, 1,5-diaminopentane, 1,6-diaminohexane, and ethylenediamine. In some aspects, the C2 to C6 alkylene of the alkane diamine is substituted with one or more alkyl groups, such as methyl.

In some aspects, Z is aryl. In some aspects, the aryl diamine is 1,3-phenylenediamine, methylene dianiline, 1,4-phenylenediamine (PDA), or a combination thereof. In some aspects, the diamine is 1,3-phenylenediamine. In some aspects, the diamine is 1,4-phenylenediamine (PDA).

With continued reference to Scheme 1, a tetracarboxylic acid dianhydride is added. In some aspects, more than one tetracarboxylic acid dianhydride is added. Combinations of tetracarboxylic acid dianhydrides may be used in order to optimize the properties of the gel material. In some aspects, a single tetracarboxylic acid dianhydride is added. The structure of the tetracarboxylic acid dianhydride may vary. In some aspects, the tetracarboxylic acid dianhydride has a structure according to Formula II, where L comprises an alkylene group, a cycloalkylene group, an arylene group, or a combination thereof, each as described herein above. In some aspects, L comprises an arylene group. In some aspects, L comprises a phenyl group, a biphenyl group, or a diphenyl ether group. In some aspects, the tetracarboxylic acid dianhydride of Formula II has a structure selected from one or more structures as provided in Table 1.

TABLE 1
Non-limiting list of potential tetracarboxylic acid dianhydrides

| Structure | IUPAC Name | Common/Alternative Name |
|---|---|---|
| 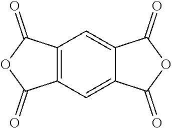 [SMILES: O=c1oc(=O)c2cc3c(=O)oc(=O)c3cc12] | 1H,3H-benzo[1,2-c:4,5-c′]difuran- 1,3,5,7-tetraone | pyromellitic anhydride (PMDS) |
| 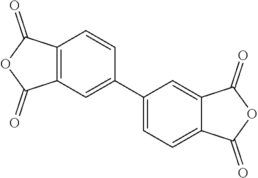 [SMILES: O=C1OC(=O)c2cc(-c3ccc4c(c3)C(=O)OC4=O)ccc21] | [5,5′-biisobenzofuran]-1,1′,3,3′- tetraone | 3,3′,4,4′- bisphenyltetracarboxylic dianhydride; biphthalic dianhydride (BPDA) |
| 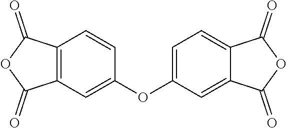 [SMILES: O=C1OC(=O)c2cc(Oc3ccc4c(c3)C(=O)OC4=O)ccc21] | 5,5′-oxybis(isobenzofuran-1,3- dione) | 4,4′-oxydiphthalic dianhydride (ODPA) |
| 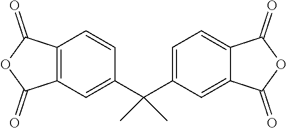 [SMILES: CC(C)(c1ccc2c(c1)C(=O)OC2=O)c1ccc2c(c1)C(=O)OC2=O] | 5,5′-(propane-2,2- diyl)bis(isobenzofuran-1,3-dione) | 4,4′- (isopropylidene)diphathalic dianhydride |
| 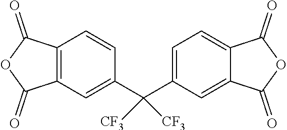 [SMILES: O=C1OC(=O)c2cc(C(c3ccc4c(c3)C(=O)OC4=O)(C(F)(F)F)C(F)(F)F)ccc21] | 5,5′-(perfluoropropane-2,2- diyl)bis(isobenzofuran-1,3-dione) | 4,4′- (hexafluoroisopropylidene)di- phathalic dianhydride (6FDA) |
| 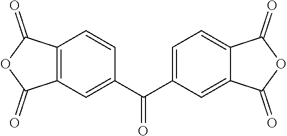 [SMILES: O=C(c1ccc2c(c1)C(=O)OC2=O)c1ccc2c(c1)C(=O)OC2=O] | 5,5′-carbonylbis(isobenzofuran-1,3- dione) | 3,3′,4,4′- benzophenonetetracarboxylic dianhydride (BTDA) |
| 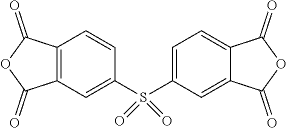 [SMILES: O=C1OC(=O)c2cc(S(=O)(=O)c3ccc4c(c3)C(=O)OC4=O)ccc21] | 5,5′-sulfonylbis(isobenzofuran-1,3- dione) | 3,3′,4,4′- diphenylsulfonetetracarboxylic dianhydride |
| 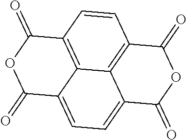 [SMILES: O=C1OC(=O)c2ccc3c4c(ccc1c24)C(=O)OC3=O] | isochromeno[6,5,4- def]isochromene-1,3,6,8-tetraone | 1,4,5,8- Naphthalenetetracarboxylic dianhydride |
| 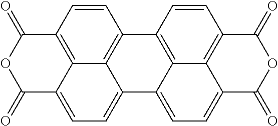 [SMILES: O=C1OC(=O)c2ccc3c4ccc5c6c(ccc(c7ccc1c2c73)c64)C(=O)OC5=O] | anthra[2,1,9-def:6,5,10- d′e′f]diisochromene-1,3,8,10- tetraone | perylene tetracarboxylic anhydride |
| 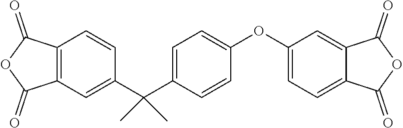 [SMILES: CC(C)(c1ccc(Oc2ccc3c(c2)C(=O)OC3=O)cc1)c1ccc2c(c1)C(=O)OC2=O] | 5-(2-(4-((1,3-dioxo-1,3- dihydroisobenzofuran-5- yl)oxy)phenyl)propan-2- yl)isobenzofuran-1,3-dione | |
| 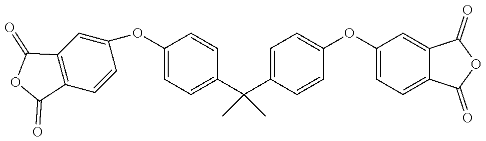 [SMILES: CC(C)(c1ccc(Oc2ccc3c(c2)C(=O)OC3=O)cc1)c1ccc(Oc2ccc3c(c2)C(=O)OC3=O)cc1] | 5,5′-((propane-2,2-diylbis(4,1- phenylene))bis(oxy))bis(isobenzo- furan-1,3-dione) | 4,4′-(4,4′)- isopropylidenediphenoxy)bisph- thalic dianhydride (BPADA) |

In some aspects, the tetracarboxylic acid dianhydride is selected from the group consisting of pyromellitic dianhydride (PMDA), biphthalic dianhydride (BPDA), oxydiphthalic dianhydride (ODPA), benzophenone tetracarboxylic dianhydride (BTDA), ethylenediaminetetraacetic dianhydride (EDDA), 1,4,5,8-naphthalenetetracarboxylic dianhydride, and combinations thereof. In some aspects, the tetracarboxylic acid dianhydride is PMDA.

The methods as disclosed herein utilize a water-soluble carbonate or bicarbonate salt. The water-soluble carbonate or bicarbonate salt may vary. As used herein, the term “water-soluble” with respect to the salt means that the carbonate or bicarbonate salt has appreciable solubility in water, such that synthetically useful concentrations of the carbonate or bicarbonate anion can be obtained under the conditions utilized in the disclosed method. For example, water-soluble carbonate or bicarbonate salts suitable for use in the disclosed methods may have a solubility in water at 20° C. of at least about 0.1 g per 100 mL, at least about 1 g per 100 mL, or at least about 10 g per 100 mL.

As used herein, the term “carbonate or bicarbonate salt” refers to an alkaline material comprising a carbonate or bicarbonate anion, and specifically excludes alkaline materials comprising carbon-hydrogen covalent bonds (i.e., organic bases, including, but not limited to, alkyl amines, aryl amines, and heteroaromatic amines). Water-soluble carbonate or bicarbonate salts suitable for use in the disclosed method may further be described as non-nucleophilic, meaning that the carbonate or bicarbonate salt does not take part in chemical reactions by donating an electron pair other than as a proton acceptor.

In particular aspects, the water-soluble carbonate or bicarbonate salt is a carbonate. In other particular aspects, the water-soluble carbonate or bicarbonate salt is a bicarbonate. With continued reference to Scheme 1, the water-soluble carbonate or bicarbonate salt has a general formula M₂CO₃ or MHCO₃, where M is a cationic species having a valence of +1.

In some aspects, the cationic species M comprises or is an ammonium ion, a guanidinium ion, or an alkali metal ion. In some aspects, the cationic species M comprises lithium, sodium, potassium, ammonium, guanidinium, or combinations thereof. In some aspects, the cationic species M is lithium. In some aspects, the cationic species M is sodium. In some aspects, the cationic species M is potassium. In some aspects, the cationic species M is ammonium (NH₄⁺). In some aspects, the cationic species M is guanidinium (NH₂—C(═NH₂⁺)—NH₂).

Particularly suitable water-soluble carbonate and bicarbonate salts include those of alkali metals. In some aspects, the water-soluble carbonate or bicarbonate salt is selected from the group consisting of lithium carbonate, lithium bicarbonate, sodium carbonate, sodium bicarbonate, potassium carbonate, potassium bicarbonate, and combinations thereof. In some aspects, the water-soluble carbonate or bicarbonate salt is selected from the group consisting of lithium carbonate, lithium bicarbonate, sodium carbonate, sodium bicarbonate, potassium carbonate, and potassium bicarbonate.

In some aspects, the water-soluble carbonate or bicarbonate salt is selected from the group consisting of ammonium carbonate, ammonium bicarbonate, guanidinium carbonate, and combinations thereof.

In some aspects, the water-soluble carbonate or bicarbonate salt is guanidinium carbonate. As described herein above, and below with respect to the Examples, certain polyamic acid salt solutions prepared with guanidinium carbonate are thixotropic. This thixotropic behavior may be desirable in for example, 3D printing applications. For example, 3D printed structures are prepared by needle deposition (moving the needle in a predetermined fashion to form a desirable pattern as the polymer solution exits the needle) of thixotropic solutions as described herein (e.g., aqueous guanidinium polyamates). The resulting structures may be processed as previously described in the literature to form either polymer or carbon aerogels that retain the imposed structure.

The quantity of water-soluble carbonate or bicarbonate salt added may vary, and may depend on, for example, the stoichiometry of the particular salt utilized. For example, one of skill in the art will recognize that depending on the charge associated with the particular anion species (carbonate or bicarbonate) present in the salt. For example, sodium bicarbonate (NaHCO₃) will supply one equivalent of base (bicarbonate ions, HCO₃⁻), each capable of reacting with one proton, and will further provide one equivalent of sodium ions for each molar equivalent of sodium bicarbonate. In contrast, sodium carbonate (Na₂CO₃) will supply two equivalents of base (carbonate ions, CO₃²⁻) capable of reacting with the two equivalents of protons coming from each repeat unit of the polyamic acid, and two equivalents of sodium ions for each molar equivalent of sodium carbonate.

The amount of water-soluble carbonate or bicarbonate salt may be expressed in terms of mole ratio to another reaction component (e.g., diamine). The molar ratio of the water-soluble carbonate or bicarbonate salt to the diamine may require optimization for each set of reactants and conditions. In some aspects, the molar ratio is selected so as to maintain solubility of the polyamic acid. In some aspects, the molar ratio is selected so as to avoid any precipitation of the polyamic acid. In some aspects, the molar ratio of the water-soluble carbonate or bicarbonate salt to the diamine is in a range from about 1 to about 4, or from about 2 to about 3. In some aspects, the molar ratio is from about 1.0, about 1.1, about 1.2, about 1.3, about 1.4, or about 1.5, to about 1.6, about 1.7, about 1.8, about 1.9, or about 2.0. In some aspects, a molar ratio of the water-soluble carbonate or bicarbonate salt to the diamine is from about 2.0 to about 2.6, such as about 2.0, about 2.1, about 2.2, about 2.3, about 2.4, about 2.5, or about 2.6. Without wishing to be bound by any particular theory, it is believed that in some exemplary aspects, at least enough base is required to allow neutralization of substantially all free carboxylic acid groups of the polyamic acid (i.e., form a salt with). In some aspects, the quantity of water-soluble carbonate or bicarbonate salt utilized is the amount which neutralizes substantially all carboxylic acid groups present in the polyamic acid formed during the reaction.

In some aspects, the water-soluble salt is a carbonate, such as lithium, sodium, potassium, ammonium or guanidinium carbonate, and the molar ratio of carbonate ions to the diamine is from about 1.0 to about 1.3.

In some aspects, the water-soluble carbonate or bicarbonate salt is a bicarbonate, such as lithium, sodium, potassium, or ammonium bicarbonate, and the molar ratio of bicarbonate ions to the diamine is from about 2.0 to about 2.6.

In some aspects, the quantity of water-soluble carbonate or bicarbonate salt present may be expressed relative to the carboxylic acid groups of the polyamic acid formed during the reaction or otherwise present in the reaction mixture. In some aspects, the water-soluble carbonate or bicarbonate salt is a bicarbonate, such as lithium, sodium, potassium or ammonium bicarbonate, and the molar ratio of bicarbonate ions to the carboxylic acid groups of the polyamic acid is about 2.0. In some aspects, the water-soluble carbonate or bicarbonate salt is a carbonate, such as lithium, sodium, potassium, or ammonium carbonate, and the molar ratio of carbonate ions to the carboxylic acid groups of the polyamic acid is about 1.0.

The relative quantities of diamine and dianhydride present may be expressed by a molar ratio. The molar ratio of the diamine to the dianhydride may vary according to desired reaction time, reagent structure, and desired material properties. In some aspects, the molar ratio is from about 0.1 to about 10, such as from about 0.1, about 0.5, or about 1, to about 2, about 3, about 5, or about 10. In some aspects, the ratio is from about 0.5 to about 2. In some aspects, the ratio is about 1 (i.e., stoichiometric), such as from about 0.9 to about 1.1. In specific aspects, the ratio is from about 0.99 to about 1.01.

The molecular weight of the polyamic acid may vary based on reaction conditions (e.g., concentration, temperature, duration of reaction, nature of diamine and dianhydride, etc.). The molecular weight is based on the number of polyamic acid repeat units, as denoted by the value of the integer “n” for the structure of Formula III in Scheme 1. The specific molecular weight range of polymeric materials produced by the disclosed method may vary. Generally, the noted reaction conditions may be varied to provide a gel with the desired physical properties without specific consideration of molecular weight. In some aspects, a surrogate for molecular weight is provided in the viscosity of the polyamic acid salt solution, which is determined by variables such as temperature, concentrations, molar ratios of reactants, reaction time, and the like.

The temperature at which the reaction is conducted may vary. A suitable range is generally between about 4° C. and about 100° C. In some aspects, the reaction temperature is from about 15 to about 60° C., such as about 20, about 25, about 30, about 35, about 40, about 45, about 50, about 55, or about 60° C. In some aspects, the temperature is from about 15 to about 25° C. In some aspects, the temperature is from about 50 to about 60° C.

The reaction is allowed to proceed for a period of time and is generally allowed to proceed until all of the available reactants (e.g., diamine and dianhydride) have reacted with one another. The time required for complete reaction may vary based on reagent structures, concentration, temperature. In some aspects, the reaction time is from about 1 minute to about 1 week, for example, from about 15 minutes to about 5 days, from about 30 minutes to about 3 days, or from about 1 hour to about 1 day. In some aspects, the reaction time is from about 1 hour to about 12 hours.

The concentration of the polyamic acid salt in the aqueous solution may vary. For example, in some aspects, the range of concentration of the polyamic acid salt in the aqueous solution is from about 0.01 to about 0.3 g/cm³, based on the weight of the polyamic acid.

In some aspects, the polyamic acid, polyimide, or carbon gel and aerogel materials as disclosed herein may be doped with one or more additional materials, such as electroactive materials, conventional polymeric fillers, carbon materials, and the like. Such dopants or precursors thereof may be introduced at various stages and in various manners. In some aspects, the dopant is introduced during or immediately following formation of the polyamic acid salt solution. Accordingly, in some aspects, the method further comprises adding a dopant to the aqueous solution of the polyamic acid salt, or to the solution of the water-soluble diamine.

In some aspects, the dopant is an electroactive material or precursor thereof. Suitable electroactive materials include, but are not limited to, graphite, silicon, such as silicon particles, tin, or species such as Prussian blue, lithium iron phosphate, lithium iron manganese phosphate, a combination thereof, other anode and/or cathode active materials, or a one or more precursors of any thereof. In some aspects, the electroactive material or precursor thereof is in particulate form. In some aspects, the dopant is a particulate material in the nanometer or micron range (i.e., having particles with two or three dimensions in the range of about 1 nm to about 10 micrometers or larger.

In some aspects, the dopant in particulate form comprises silicon, such as silicon, silicon wires, crystalline silicon, amorphous silicon, silicon alloys, silicon oxides (SiOx), silicon carbide, silicon nitride, coated silicon, e.g., carbon coated silicon, and any combinations of silicon particle materials disclosed herein.

In some aspects, the dopant in particulate form comprises carbon, graphite, tin, sulfur, nickel, manganese, cobalt, iron, vanadium, manganese, or combinations thereof. For example, in some aspects, the dopant in particulate form is a lithium iron phosphate or a manganese or vanadium variant thereof.

The dopant particles (e.g., lithium iron phosphate) may be incorporated into the polyamic acid, polyimide, or carbon gels as disclosed herein in a number of ways. Generally, electroactive dopant particles (e.g., lithium iron phosphate) are incorporated during the sol-gel process. In one non-limiting aspect, electroactive dopant particles (e.g., lithium iron phosphate) are dispersed in the polyamic acid sol prior to imidization. In some aspects, electroactive dopant particles (e.g., lithium iron phosphate) are dispersed in a solvent, e.g., water, or a polar, aprotic solvent, before combination with the polyimide precursors. In some aspects, electroactive dopant particles (e.g., lithium iron phosphate) are dispersed in the polyamic acid sol during the imidization process. In some aspects, electroactive dopant particles (e.g., lithium iron phosphate) are added to an aqueous solution of a polyamic acid salt. In other aspects, precursors of an electroactive material (e.g., sulfur or sulfur itself, or materials comprising nickel, manganese, cobalt, iron, vanadium, manganese, phosphate, Prussian blue, or the like) may be introduced at various stages, including but not limited to, during preparation of the polyamic acid salt.

In some aspects, residual lithium, sodium, potassium, ammonium or guanidinium ions from e.g., the water-soluble carbonate or bicarbonate salt, are retained in the polyamic acid, polyimide, or carbon gel material.

### Polyamic Acid and Polyimide Gels

In some aspects, the method further comprises converting the aqueous solution of the polyamic acid salt to the corresponding polyamic acid gel. Generally, the method of converting the polyamic acid salt solution to the corresponding polyamic acid gel comprises acidifying the polyamic acid salt solution to convert the polyamate salt into the polyamic acid, causing phase separation of the polyamic acid as a gel. The acid may also be referred to as a gelation initiator. The acidification to form the polyamic acid generally follows Scheme 2.

The method of acidification may vary. For example, in some aspects, the polyamate salt solution is added to an acid solution, wherein acidification of the polyamate salt solution is rapid. Alternatively, the polyamate salt solution may be acidified by addition of acid to the polyamate salt solution. In some aspects, the polyamate salt solution may be acidified gradually or slowly using conditions or techniques known to one of skill in the art. For example, in one non-limiting aspect, an acid precursor is utilized. The acid precursor is a material which may be gradually converted to an acid, e.g., by hydrolysis. One such suitable acid precursor is acetic anhydride, which generates acetic acid in the presence of water.

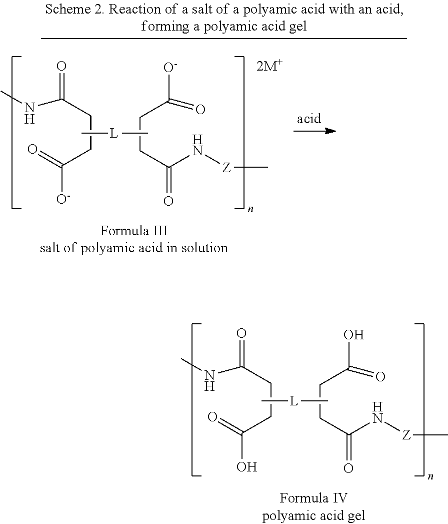

In some aspects, the polyamic acid wet gel prepared as disclosed herein, or the corresponding aerogel as described herein below, comprises residual carbonate or bicarbonate salt(s). Generally, the residual amount is a trace quantity, but the carbonate or bicarbonate, and/or the associated counter cation (e.g., alkali metal ions, guanidinium ions, and the like) may be detected by analytical methods known to one of skill in the art.

The resulting polyamic acid gel material may subsequently be dried to form a polyamic acid aerogel. Methods of acidification and formation of the polyamic acid gel material are described in, for example International Patent Application Publication No. WO2022125835, which is incorporated herein in its entirety. Methods of drying to form the corresponding aerogel are described further herein below.

In some aspects, the method further comprises forming a polyimide aerogel from the aqueous solution of the polyamic acid salt. Generally, the method comprises imidizing the polyamic acid salt to form a polyimide gel; and drying the polyimide gel to form the polyimide aerogel. Methods of imidizing the aqueous solution of the polyamic acid salt are described in, for example International Patent Application PCT/US2021/062706, which is incorporated herein in its entirety, and suitable methods are also described further herein below. Methods of drying to form the corresponding polyimide aerogel are described further herein below.

In some aspects, imidizing the polyamic acid salt comprises thermally imidizing the corresponding polyamic acid. Irradiation of the wet gel polyamic acid material with microwave frequency energy is one particularly suitable thermal treatment. In comparison to conventional heating, which relies on slow thermal conduction, microwave heating allows rapid and efficient energy transfer. Accordingly, microwave heating is particularly suitable for conducting the present thermal imidization reactions. Generally, the microwave frequency irradiation is at a power and for a length of time sufficient to convert a substantial portion of the amide and carboxyl groups of the polyamic acid to imide groups. As used herein in the context of converting the amide and carboxyl groups to imide groups, “substantial portion” means that greater than 80%, such as 85%, 90%, 95%, 99%, or 99.9%, or 99.99%, or even 100%, of the amide and carboxyl groups are converted to imide groups.

In other aspects, imidizing the polyamic acid salt comprises performing chemical imidization, where chemical imidization comprises adding a gelation initiator to the aqueous solution of the salt of the polyamic acid to form a gelation mixture (a “sol”), and allowing the gelation mixture to gel (e.g., in molds, or cast on sheet, or in other various formats, such as beads). In such aspects, the gelation initiator is added to initiate and drive imidization, forming the polyimide wet gel from the polyamic acid salt. A non-limiting, generic reaction sequence is provided in Scheme 3. In some aspects, the polyimide has a structure according to Formula V as illustrated in Scheme 3, wherein L, Z, and n are each as described herein above with respect to forming the polyamic acid salt of Formula III.

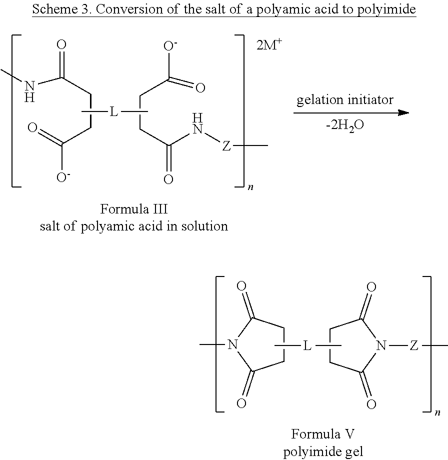

The structure of the gelation initiator may vary but is generally a reagent that is at least partially soluble in the reaction solution, reactive with the carboxylate groups of the polyamic acid salt, and effective in driving the imidization of the polyamic acid carboxyl and amide groups, while having minimal reactivity with the aqueous solution. One example of a class of suitable gelation initiator is the carboxylic acid anhydrides, such as acetic anhydride, propionic anhydride, and the like. In some aspects, the gelation initiator is acetic anhydride.

In some aspects, the quantity of gelation initiator may vary based on the quantity of tetracarboxylic acid dianhydride or polyamic acid. For example, in some aspects, the gelation initiator is present in various molar ratios with the tetracarboxylic acid dianhydride. In some aspects, the gelation initiator is present in various molar ratios with the polyamic acid. The molar ratio of the gelation initiator to the tetracarboxylic acid dianhydride or polyamic acid may vary according to desired reaction time, reagent structure, and desired material properties. In some aspects, the molar ratio is from about 2 to about 10, such as from about 2, about 3, about 4, or about 5, to about 6, about 7, about 8, about 9, or about 10. In some aspects, the ratio is from about 2 to about 5.

The temperature at which the gelation reaction is allowed to proceed may vary, but is generally less than about 50° C., such as from about 10 to about 50° C., or from about 15 to about 25° C.

The gelation conditions described above (both acidification and imidization) are general and intended to be non-limiting with respect to the manner in which the gelation is performed. For example, one of skill in the art will recognize various permutations in which monoliths or beads, including microbeads are prepared. For example, contemplated herein are methods of forming monoliths by casting the gelling mixture in a mold, methods of forming beads of various sizes by dropping or spraying the polyamic acid salt solution into an acidic receiving solution, or forming micron-sized beads of polyamic acid or polyimide gels in an emulsion. Further contemplated herein are methods of forming polyamic acid metal salt gels by contacting the polyamic acid salt solution with certain metal ions in solution (see, e.g., Scheme 4). With reference to Scheme 4, certain metal salts (e.g., alkaline earth metal salts, d-block element salts, p-block element salts, lanthanide metal salts, actinide metal salts) form metal polyamate gels with desirable properties. These additional gelation methods (i.e., metal polyamate salt, beads monoliths) are described in, for example, International Patent Application Publication No. WO2022/125835 to Leventis et al., which is incorporated herein by reference with respect to disclosure of polyamic acid, polyimide, and metal polyamate gel formation from aqueous solutions.

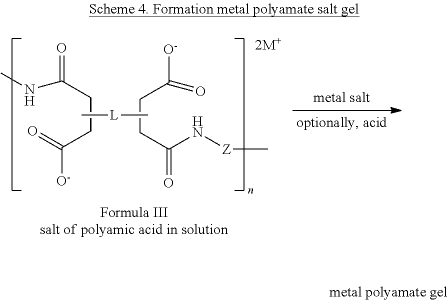

One of skill in the art will recognize that polyimide wet gels prepared according to the methods described herein will have unreacted terminal amino groups on one end or on both ends of the individual polymer chains. The percent concentration of such amino groups in the polyimide wet gel will vary in inverse proportion to the average number of repeat units (i.e., the molecular weight) present in the polyimide wet gel. In some aspects, the terminal amino groups may undergo reaction with the gelation initiator (e.g., acetic anhydride) to form, e.g., terminal amides such as acetamides. The relative concentration of such terminal amines or amides may be determined according to methods known in the art, including, but not limited to, nuclear magnetic resonance spectroscopy, such as solid state 15N-NMR.

In some aspects, the water content in a polyimide wet gel prepared as disclosed herein, prior to any solvent exchange or drying, is essentially the entire quantity of water initially utilized as the reaction solvent, not accounting for any evaporation, or water produced or destroyed in the various reactions which occur during the polyimide synthesis as described herein above.

In some aspects, the polyimide wet gel prepared as disclosed herein, or the corresponding aerogel as described herein below, comprises residual carbonate or bicarbonate salt(s). Generally, the residual amount is a trace quantity, but the carbonate or bicarbonate, and/or the associated counter cation (e.g., alkali metal ions, guanidinium ions, and the like) may be detected by analytical methods known to one of skill in the art.

### Polyamic Acid, Polyimide and Metal Polyamate Salt Aerogels

As noted herein above, in some aspects, the method further comprises converting the polyamic acid salt, via the corresponding polyamic acid, polyimide or metal polyamate salt wet gel, to an aerogel material. Generally, formation of an aerogel comprises drying the wet gel in one or more stages. In some aspects, the wet gel (polyamic acid, polyimide or metal polyamate) is aged. Following any aging, the resulting wet gel material, may be collected (e.g., demolded) and washed or solvent exchanged first with water to remove any unreacted organic salts or acids, and then in a suitable secondary solvent to replace the primary reaction solvent (i.e., water) present in the wet gel. Such secondary solvents should be miscible with supercritical fluid carbon dioxide (CO₂) and include linear alcohols with 1 or more aliphatic carbon atoms, diols with 2 or more carbon atoms, or branched alcohols, cyclic alcohols, alicyclic alcohols, aromatic alcohols, polyols, ethers, ketones, cyclic ethers or their derivatives. In some aspects, the secondary solvent is water, a C1 to C4 alcohol (e.g., methanol, ethanol, propanol, isopropanol, or n-, iso-, or sec-butanol), acetone, tetrahydrofuran, ethyl acetate, acetonitrile, supercritical fluid carbon dioxide (CO₂), or a combination thereof. In some aspects, the secondary solvent is ethanol.

Once the wet gel has been formed and processed, the liquid phase of the wet gel can then be at least partially extracted from the wet gel material using extraction methods, including processing and extraction techniques, to form an aerogel material (i.e., “drying”). Liquid phase extraction, among other factors, plays an important role in engineering the characteristics of aerogels, such as porosity and density, as well as related properties such as thermal conductivity. Generally, aerogels are obtained when a liquid phase is extracted from a wet gel in a manner that causes low shrinkage to the porous network and the solid framework of the wet gel. Wet gels can be dried using various techniques to provide aerogels or xerogels. In exemplary aspects, wet gel materials can be dried at ambient pressure, under vacuum (e.g., through freeze drying), at subcritical conditions, or at supercritical conditions to form the corresponding dry gel (e.g., an aerogel, such as a xerogel).

In some aspect, it may be desirable to reduce the surface area of the dry gel. If reduction of the surface area is desired, aerogels can be converted completely or partially to xerogels with various porosities. The high surface area of aerogels can be reduced by forcing some of the pores to collapse. This can be done, for example, by immersing the aerogels for a certain time in solvents such as ethanol or acetone or by exposing them to solvent vapor. The solvents are subsequently removed by drying at ambient pressure.

Aerogels are commonly formed by removing the liquid mobile phase from the wet gel material at a temperature and pressure near or above the critical point of the liquid mobile phase. Once the critical point is reached (near critical) or surpassed (supercritical; i.e., pressure and temperature of the system is at or higher than the critical pressure and critical temperature, respectively) a new supercritical phase appears in the fluid that is distinct from the liquid or vapor phase. The solvent can then be removed without introducing a liquid-vapor interface, capillary forces, or any associated mass transfer limitations typically associated with receding liquid-vapor boundaries. Additionally, the supercritical phase is more miscible with organic solvents in general, thus having the capacity for better extraction. Co-solvents and solvent exchanges are also commonly used to optimize the supercritical fluid drying process.

If evaporation or extraction occurs below the supercritical point, capillary forces generated by liquid evaporation can cause shrinkage and pore collapse within the gel material. Maintaining the mobile phase near or above the critical pressure and temperature during the solvent extraction process reduces the negative effects of such capillary forces. In certain aspects of the present disclosure, the use of near-critical conditions just below the critical point of the solvent system may allow production of aerogels or compositions with sufficiently low shrinkage, thus producing a commercially viable end-product.

Wet gels can be dried using various techniques to provide aerogels. In example aspects, wet gel materials can be dried at ambient pressure, at subcritical conditions, or at supercritical conditions.

Both room temperature and high temperature processes can be used to dry gel materials at ambient pressure. In some aspects, a slow ambient pressure drying process can be used in which the wet gel is exposed to air in an open container for a period of time sufficient to remove solvent, e.g., for a period of time in the range of hours to weeks, depending on the solvent, the quantity of wet gel, the exposed surface area, the size of the wet gel, and the like.

In another aspect, the wet gel material is dried by heating. For example, the wet gel material can be heated in a convection oven for a period of time to evaporate most of the solvent (e.g., ethanol). After partially drying, the gel can be left at ambient temperature to dry completely for a period of time, e.g., from hours to days. This method of drying produces xerogels. Notably, according to the present disclosure, it was found that drying of wet gels in monolithic form resulted in cracking, but wet gels in bead form retained their spherical shape even from lower target-density, Td, solutions (e.g., Td=0.05 g cm³).

In some aspects, the wet gel material is dried by freeze-drying. By “freeze drying” or “lyophilizing” is meant a low temperature process for removal of solvent that involves freezing a material (e.g., the wet gel material), lowering the pressure, and then removing the frozen solvent by sublimation. As water represents an ideal solvent for removal by freeze drying, and water is the solvent in the method as disclosed herein, freeze drying is particularly suited for aerogel formation from the disclosed polyimide wet gel materials. This method of drying produces cryogels, which may closely resemble aerogels.

Both supercritical and sub-critical drying can be used to dry wet gel materials. In some aspects, the wet gel material is dried under subcritical or supercritical conditions. In an example aspect of supercritical drying, the gel material can be placed into a high-pressure vessel for extraction of solvent with supercritical CO₂. After removal of the solvent, e.g., ethanol, the vessel can be held above the critical point of CO₂ for a period of time, e.g., about 30 minutes. Following supercritical drying, the vessel is depressurized to atmospheric pressure. Generally, aerogels are obtained by this process.

In an example aspect of subcritical drying, the gel material is dried using liquid CO₂ at a pressure in the range of about 800 psi to about 1200 psi at room temperature. This operation is quicker than supercritical drying; for example, the solvent (e.g., ethanol) can be extracted in about 15 minutes. Generally, aerogels are obtained by this process.

Several additional aerogel extraction techniques are known in the art, including a range of different approaches in the use of supercritical fluids in drying aerogels, as well as ambient drying techniques. For example, U.S. Pat. No. 6,670,402 teaches extracting a liquid phase from a gel via rapid solvent exchange by injecting supercritical (rather than liquid) carbon dioxide into an extractor that has been pre-heated and pre-pressurized to substantially supercritical conditions or above, thereby producing aerogels.

In some aspects, extracting the liquid phase from the wet gel uses supercritical conditions of CO₂.

Formation of Carbon Aerogels from Polyamic Acid or Polyimide Aerogels

In some aspects, the method further comprises converting the polyamic acid or polyimide aerogel to an isomorphic carbon aerogel, the converting comprising pyrolyzing the respective aerogel under suitable conditions. Accordingly, in some aspects, the method further comprises pyrolyzing (e.g., carbonizing) a polyamic acid or polyimide aerogel as disclosed herein, meaning the aerogel is heated at a temperature and for a time sufficient to convert substantially all of the organic material into carbon. As used herein in the context of pyrolysis, “substantially all” means that greater than 80% by weight of the organic material is converted to carbon, such as 80%, 85%, 90%, or greater, such as up to 99%, 99.9%, 99.99%, or even 100% of the organic material by weight is converted to carbon. Pyrolyzing the aerogel converts the aerogel to an isomorphic carbon aerogel, meaning the physical properties (e.g., porosity, surface area, pore size, diameter, and the like) are substantially retained in the corresponding carbon aerogel. The time and temperature required for pyrolyzing may vary. In some aspects, the polyimide aerogel is subjected to a treatment temperature of about 650° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the aerogel. Generally, the pyrolysis is conducted under an inert atmosphere to prevent combustion of the organic or carbon material. Suitable atmospheres include, but are not limited to, nitrogen, argon, or combinations thereof. In some aspects, pyrolysis is performed under nitrogen.

In some aspects, the aerogel is a metal polyamate salt aerogel as described herein above. Upon pyrolysis of such metal polyamate salt aerogels, the resulting carbon aerogel may comprise (i.e., be doped with) the corresponding metal, metal oxide, metal carbide, or combination thereof. The species present is dependent upon the pyrolysis conditions, such as the temperature and reducing atmosphere, as well as the specific metal ion.

### Properties of the Aerogels

Aerogels as disclosed herein have a density. As used herein, the term “density” refers to a measurement of the mass per unit volume of an aerogel material or composition. The term “density” generally refers to the true or skeletal density of an aerogel material, as well as the bulk density of an aerogel article. Density is typically reported as kg/m³ or g/cm³. The skeletal density of an aerogel (polyamic acid, polyimide, poyamate metal salt, or carbon) may be determined by methods known in the art, including, but not limited to helium pycnometry. The bulk density of an aerogel (polyamic acid, polyimide, or carbon) may be determined by methods known in the art, including, but not limited to: Standard Test Method for Dimensions and Density of Preformed Block and Board-Type Thermal Insulation (ASTM C303, ASTM International, West Conshohocken, Pa.); Standard Test Methods for Thickness and Density of Blanket or Batt Thermal Insulations (ASTM C167, ASTM International, West Conshohocken, Pa.); or Determination of the apparent density of preformed pipe insulation (ISO 18098, International Organization for Standardization, Switzerland). Within the context of the present disclosure, density measurements are acquired according to ASTM C167 standards, unless otherwise stated. In some aspects, the aerogels (polyamic acid, polyimide, poyamate metal salt, or carbon) as disclosed herein have a bulk density from about 0.01 to about 1, such as from about 0.1 to about 0.3 g/cm³.

Aerogels as disclosed herein have a pore size distribution. As used herein, the term “pore size distribution” refers to the statistical distribution or relative amount of each pore size within a sample volume of a porous material. A narrower pore size distribution refers to a relatively large proportion of pores at a narrow range of pore sizes. In some aspects, a narrow pore size distribution may be desirable in e.g., optimizing the amount of pores that can surround an electrochemically active species and maximizing use of the available pore volume. Conversely, a broader pore size distribution refers to relatively small proportion of pores at a narrow range of pore sizes. As such, pore size distribution is typically measured as a function of pore volume and recorded as a unit size of a full width at half max of a predominant peak in a pore size distribution chart. The pore size distribution of a porous material may be determined by methods known in the art. Suitable methods for determination of pore size distributions include, but are not limited to, measurements of gas adsorption/desorption (e.g., nitrogen), mercury porosimetry, and the like. Measurements of pore size distribution reported herein are acquired by nitrogen sorption analysis unless otherwise stated. In certain aspects, aerogels (e.g., polyamic acid, polyimide, poyamate metal salt, or carbon) of the present disclosure have a relatively narrow pore size distribution.

Aerogel materials as disclosed herein have a pore volume. As used herein, the term “pore volume” refers to the total volume of pores within a sample of porous material. Pore volume is specifically measured as the volume of void space within the porous material and is typically recorded as cubic centimeters per gram (cm³/g or cc/g). The pore volume of a porous material may be determined by methods known in the art, for example including, but not limited to, nitrogen porosimetry, mercury porosimetry, or via a combination of helium pycnometry and determination of the bulk density. In certain aspects, aerogels (polyamic acid, polyimide, or carbon) of the present disclosure have a relatively large pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other aspects, aerogels and xerogels (polyamic acid, polyimide, or carbon) of the present disclosure have a pore volume of about 0.03 cc/g or more, 0.1 cc/g or more, 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values.

In some aspects of the disclosure, the aerogel materials (polyamic acid, polyimide, or carbon, aerogel or xerogel) may comprise a fibrillar morphology. Within the context of the present disclosure, the term “fibrillar morphology” refers to the structural morphology of a nanoporous material (e.g., a carbon aerogel) being inclusive of struts, rods, fibers, or filaments.

In some aspects, a carbon aerogel produced by any of the disclosed methods has properties substantially similar to those of a carbon aerogel prepared by pyrolyzing a corresponding polyimide aerogel that has been prepared by a conventional, non-aqueous method. See, e.g., U.S. Pat. Nos. 7,071,287 and 7,074,880 to Rhine et al.

In some aspects, the carbon aerogel materials of the present disclosure, e.g., polyamic acid-derived, polyamate metal salt-derived, or polyimide-derived carbon aerogels) can have a residual “hetero-atom” (i.e., non-carbon atom) nitrogen content of at least about 1 wt % as determined by elemental analysis. For example, carbon aerogel materials can have a residual nitrogen content of at least about 1 wt %, and up to about 10 wt %. In some aspects, the residual nitrogen content is about 1, about 2, about 3, about 4, about 5, about 6, about 7, about 8, about 9, or about 10 wt %.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed. No language in the specification should be construed as indicating any non-claimed element as essential to the practice of the disclosed materials and methods.

It will be readily apparent to one of ordinary skill in the relevant arts that suitable modifications and adaptations to the compositions, methods, and applications described herein can be made without departing from the scope of any aspects thereof. The compositions and methods provided are exemplary and are not intended to limit the scope of the claimed aspects. All of the various aspects and options disclosed herein can be combined in all variations. The scope of the compositions, formulations, methods, and processes described herein include all actual or potential combinations of aspects, options, examples, and preferences herein.

Although the technology herein has been described with reference to particular aspects, it is to be understood that these aspects are merely illustrative of the principles and applications of the present technology. It will be apparent to those skilled in the art that various modifications and variations can be made to the method and apparatus of the present technology without departing from the spirit and scope of the technology. Thus, it is intended that the present technology include modifications and variations that are within the scope of the appended claims and their equivalents.

Reference throughout this specification to “one aspect,” “certain aspects,” “one or more aspects” or “an aspect” means that a particular feature, structure, material, or characteristic described in connection with the aspect is included in at least one aspect of the technology. Thus, the appearances of phrases such as “in one or more aspects,” “in certain aspects,” “in one aspect” or “in an aspect” in various places throughout this specification are not necessarily referring to the same aspect of the technology. Furthermore, the particular features, structures, materials, or characteristics may be combined in any suitable manner in one or more aspects. Any ranges cited herein are inclusive.

Aspects of the present technology are more fully illustrated with reference to the following examples. Before describing several exemplary aspects of the technology, it is to be understood that the technology is not limited to the details of construction or process steps set forth in the following description. The technology is capable of other aspects and of being practiced or being carried out in various ways. The following examples are set forth to illustrate certain aspects of the present technology and are not to be construed as limiting thereof.

### EXAMPLES

The present invention may be further illustrated by the following non-limiting examples describing the methods.

### Example 1. Preparation of Polyimide Aerogel in Water Using Li₂CO₃ as the Base (Target Density of 0.05 g/cc) and Pyrolysis to Corresponding Carbon Aerogels

p-Phenylenediamine (3.315 g, 0.03065 mol) was dissolved in 200 mL of deionized water. Lithium carbonate (2.718 g, 1.2 mol excess) was added and dissolved in the same aqueous solution. Pyromellitic dianhydride (6.685 g) was suspended in the same solution. A few minutes later, no solids were remaining in suspension. At the initial stages of the reaction, gas evolution (CO₂) was observed. The viscous yellow solution was stirred up to 4 days. Aliquots were taken every 24 hours and the viscosity was measured with a rheometer. The values were: Day 1: 76.6 cP; Day 2: 74.2 cP; Day 3: 71.0 cP; and Day 4: 70.8 cP.

At the second day, a 50 g aliquot of the viscous solution was removed and acetic anhydride (1.471 g, 2.0 molar excess relative to the monomer repeat unit contained in the aliquot) was added. The resulting solution after the addition of acetic anhydride was stirred for about 30 seconds and subsequently portioned into cylindrical molds. The solution gelled in less than 5 min. The resulting gels were transparent, light brown and rubbery, closely resembling gels obtained by the conventional route (i.e., prepared in organic solvent). The gels were aged in their molds for 24 hours at room temperature, then washed with ethanol (4 times) and dried with supercritical fluid CO₂ to provide the corresponding monolithic polyimide aerogels. These aerogels are referred to as Td005-Li2-d2-AA2. Monoliths were pyrolyzed at 1050° C. under flowing nitrogen into the corresponding carbon aerogels, designated as C-Td005-Li2-d2-AA2. Materials characterization data for both Td005-Li2-d2-AA2 and C-Td005-Li2-d2-AA2 are provided in Tables 2 and 3.

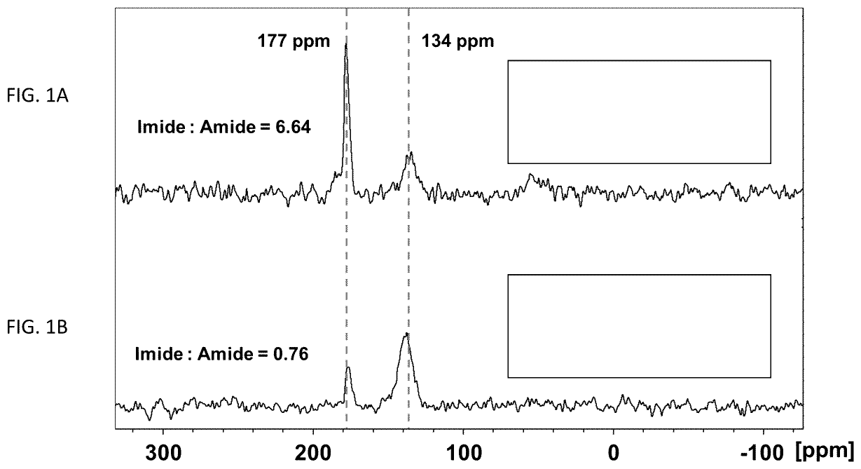

Also at the second day, another 50 g aliquot of the viscous solution was removed and acetic anhydride (1.471 g, 2.0 molar excess relative to the monomer repeat unit contained in the aliquot) was added. The resulting solution after the addition of acetic anhydride was stirred for about 30 seconds and subsequently portioned into cylindrical molds. The solution gelled in less than 5 min. The resulting gels were transparent, light brown and rubbery, closely resembling gels obtained by the conventional route (i.e., prepared in organic solvent). The gels were aged in their molds for 24 hours at 68° C., then were allowed to cool down to room temperature, they were removed from the molds, were washed with ethanol (4 times) and were dried with supercritical fluid CO₂ to provide the corresponding monolithic polyimide aerogels. These aerogels are referred to as Td005-Li2-d2-AA2-68. FIG. 1A provides a solid state ¹⁵N NMR spectrum of a polyimide aerogel obtained by aging the wet gel at 68° C., while FIG. 1B provides a solid state ¹⁵N NMR spectrum of a polyimide aerogel obtained by aging the wet gel at 25° C. Together, the overlayed spectra of FIG. 1A and FIG. 1B show that imidization is more complete when aging takes place at an elevated temperature.

Selected monoliths were pyrolyzed at 1050° C. under flowing nitrogen into the corresponding carbon aerogels, designated as C-Td005-Li2-d2-AA2-68. Materials characterization data for both Td005-Li2-d2-AA2-68 and C-Td005-Li2-d2-AA2-68 are provided in Tables 2 and 3.

At the fourth day, a 50 g aliquot of the viscous solution was removed and acetic anhydride (3.163 g, 4.3 molar excess relative to the monomer repeat unit contained in the aliquot) was added. The resulting solution after the addition of acetic anhydride was stirred for about 30 seconds and subsequently portioned into molds. The solution gelled in about 1 minute. The resulting gels were transparent, light brown and rubbery, closely resembling gels obtained by the conventional route (i.e., prepared in organic solvent). The gels samples were aged in their molds for 24 hours, then washed with ethanol (4 times) and dried with supercritical fluid CO₂ to provide the corresponding polyimide aerogels. These aerogel monoliths are referred to as Td005-Li2-d4. Selected monoliths were pyrolyzed at 1050° C. under flowing nitrogen into the corresponding carbon aerogels, designated as C-Td005-Li2-d4. Materials characterization data for both Td005-Li2-d4 and C-Td005-Li2-d4 are provided in Tables 2 and 3.

A portion of the remaining viscous yellow solution of Day 4 was dripped into an aqueous hydrochloric acid solution (30% concentrated HCl in deionized water). Polyamic acid beads were formed instantly. The beads were aged in the receiving HCl solution for 24 hours, then washed with water (4 times, 12 hours each time, using 1 L of water each time), then similarly washed with ethanol and dried with supercritical fluid CO₂ to provide the corresponding polyamic acid aerogel beads. These aerogel beads are referred to as PAA-beads-Td005-Li2-d4. Some of those beads were pyrolyzed at 1050° C. under flowing nitrogen into the corresponding carbon aerogel beads, designated as C-PAA-beads-Td005-Li2-d4. Materials characterization data for both PAA-beads-Td005-Li2-d4 and C-PAA-beads-Td005-Li2-d4 are provided in Tables 2 and 3. It is noted that the residual amount of lithium by elemental analysis in both PAA-beads-Td005-Li2-d4 and C-PAA-beads-Td005-Li2-d4 (0.02% and 0.05% weight per weight, respectively) was much less than the amount of lithium remaining in Td005-Li2-d4 and C-Td005-Li2-d4 (1.45% and 1.52% weight per weight, respectively). The reduced amount of lithium in the aerogel beads was attributed to the water washes of the wet gel beads.

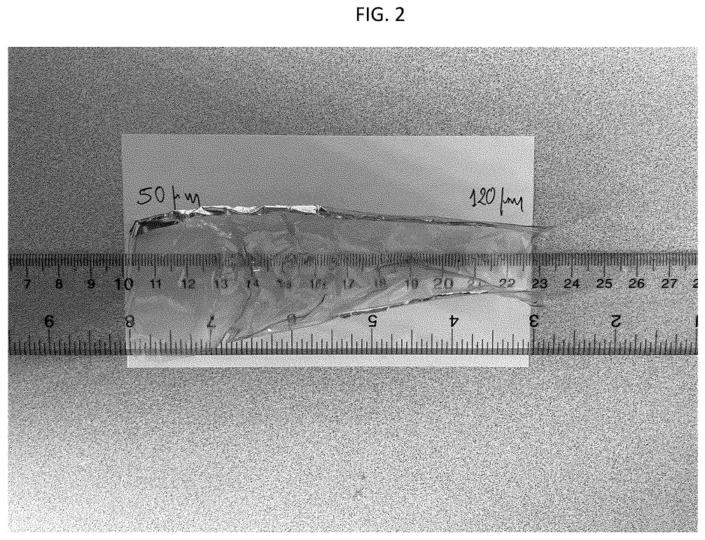

A portion of the remaining viscous yellow solution of Day 4 was treated with acetic anhydride as described above, and the gelling material was cast onto an aluminum sheet to form a thin film. The film was strong and flexible. A photographic image of the film is provided as FIG. 2. With reference to FIG. 2, one end of the film was 50 microns thick and the other one was 120 microns thick.

### Example 2. Preparation of Polyimide Aerogel in Water Using Li₂CO₃ as the Base (Target Density of 0.1 g/cc) and Pyrolysis to Corresponding Carbon Aerogels

Polyimide gels were prepared as in Example 1, but at double the target density. p-Phenylenediamine (6.63 g, 0.06131 mol) was dissolved in 200 mL of deionized water. Lithium carbonate (5.435 g, 1.2 mol excess) was added and dissolved in the same aqueous solution. Pyromellitic dianhydride (13.37 g, 0.06130 mol) was suspended in the solution. A few minutes later, no solids remained in suspension. At the initial stages of the reaction, massive gas evolution (CO₂) was observed. The viscous yellow solution was stirred for 2 days. Aliquots were taken every 24 hours and the viscosity of the aliquots measured with a rheometer. The values were: Day 1: 422 cP; and Day 2: 348 cP. On the second day, a 3.43 mol excess of acetic anhydride relative to the monomer repeat unit was added to the very viscous solution (amount of acetic anhydride: 21.512 g). The resulting solution was stirred for about 30 seconds, then divided into molds. The solution gelled in less than 1 minute. The gels were very dark, yet transparent, and rubbery, comparable to gels obtained in organic solvents by the classic routes. The gels were aged in their molds for 24 hours, then washed with ethanol (4 times) and dried with supercritical fluid CO₂. These aerogel monoliths are referred to as Td01-Li2-d2-AA3.43. Selected monoliths were pyrolyzed at 1050° C. under flowing nitrogen into the corresponding carbon aerogels, designated as C-Td01-Li2-d2-AA3.43. Materials characterization data for both Td01-Li2-d2-AA3.43 and C-Td01-Li2-d2-AA3.43 are provided in Tables 2 and 3.

### Example 3. Preparation of Polyimide Aerogel in Water Using Li₂CO₃ as the Base at Other Target Densities, and Pyrolysis to Corresponding Carbon Aerogels

Polyimide gels, aerogels and carbon aerogels were prepared as in Example 2 at target densities (Td) of 0.02 and 0.085 by adjusting accordingly the monomer concentration in the reaction mixture.

For Td=0.085, p-phenylenediamine (5.64 g, 0.0521 mol) was dissolved in 200 mL of deionized water. Lithium carbonate (4.620 g, 1.2 mol excess) was added and dissolved in the same aqueous solution. Pyromellitic dianhydride (11.36 g, 0.0521 mol) was suspended in the same solution. A few minutes later, no solids were remaining in suspension. At the initial stages of the reaction massive gas evolution (CO₂) was observed. The viscous yellow solution was stirred for 2 days. The viscosity was reassured with a rheometer at Day 2: 126.7 cP. At the second day, 4.3 mol excess of acetic anhydride relative to the monomer repeat unit was added in the very viscous solution (amount of acetic anhydride: 22.87 g). The new solution after the addition of acetic anhydride was stirred for about 30 sec and then it was divided into molds. The solution gelled in less than 1 minute. The gels were dark, yet transparent, and rubbery, like gels obtained in organic solvents by the classic routes. Gels were aged in their molds at room temperature for 24 hours. Then they were washed with ethanol (4 times) and were dried with supercritical fluid CO₂ to obtain the corresponding monolithic polyimide aerogels. These aerogel monoliths are referred to as Td0085-Li2-d2. Selected monoliths were pyrolyzed at 1050° C. under flowing nitrogen into the corresponding carbon aerogels, designated as C-Td0085-Li2-d2. Materials characterization data for both Td0085-Li2-d2 and C-Td0085-Li2-d2 are provided in Tables 2 and 3.

For Td=0.02, p-phenylenediamine (1.33 g, 0.0123 mol) was dissolved in 200 mL of deionized water. Lithium carbonate (1.087 g, 1.2 mol excess) was added and dissolved in the same aqueous solution. Pyromellitic dianhydride (2.674 g, 0.0123 mol) was suspended in the same solution. A few minutes later, no solids were remaining in suspension. Gas (CO₂) evolution was barely noticeable. The pale-yellow solution was stirred for 2 days. The viscosity was reassured with a rheometer at Day 2: 2.7 cP. At the second day, 4.3 mol excess of acetic anhydride relative to the monomer repeat unit was added in the solution (amount of acetic anhydride: 5.399 g). The new solution after the addition of acetic anhydride was stirred for about 30 sec and then it was divided into molds. Gelation took place in more than an hour. The gels were light yellow, transparent, and jelly-like. Gels were aged in their molds at room temperature for 7 days. During that time a very small amount of syneresis occurred allowing the gels to be removed from their molds. Then they were washed with ethanol (4 times) and were dried with supercritical fluid CO₂ to obtain the corresponding monolithic polyimide aerogels. These aerogel monoliths are referred to as Td002-Li2-d2-age7. Selected monoliths were pyrolyzed at 1050° C. under flowing nitrogen into the corresponding carbon aerogels, designated as C-Td002-Li2-d2-age7. Materials characterization data for both Td002-Li2-d2-age7 and C-Td002-Li2-d2-age7 are provided in Tables 2 and 3.

TABLE 2
Materials characterization data for aerogels of Examples 1-3.

| | | | | | | | | | BET/ | | Av. |
|---|---|---|---|---|---|---|---|---|---|---|---|
| | | | | | | | BET | micro | micro | | pore |
| | C | | Lin. | bulk | Skel. | | surf. | pore | pore | pore | size |
| | yield | Dia. | shrinkage | density | Dens. | Porosity | area | area | surf. | volume | (4 V/ |
| sample | (%) | (mm) | (%) | (g/cm³) | (g/cm³) | (% v/v) | (m²g⁻¹) | (m²g⁻¹) | area | (cm³ g⁻¹) | A, nm) |
| MONOLITHS | | | | | | | | | | | |
| Td002-Li2-d2- | | | 48.3 | 0.1436 | 1.2083 | 88 | 386.49 | 64.56 | 5.99 | 1.17 | 11.72 |
| age7 | | | | | | | | | | | |
| C-Td002-Li2-d2- | 27.78 | | 74.6 | 0.5137 | 1.9830 | 74 | 249.53 | 44.55 | 5.60 | 0.84 | 14.74 |
| age7 | | | | | | | | | | | |
| Td005-Li2-d4 | | | 32.4 | 0.1593 | 1.4867 | 89 | 390.46 | 32.22 | 12.12 | 1.60 | 14.12 |
| C-Td005-Li2-d4 | 42.50 | | 63.6 | 0.4447 | 1.7895 | 75 | 344.12 | 44.46 | 7.74 | 0.89 | 9.99 |
| Td005-Li2-d2- | | | 41.5 | 0.2539 | 1.5158 | 83 | 384.23 | 76.27 | 5.04 | 1.19 | 12.67 |
| AA2 | | | | | | | | | | | |
| C-Td005-Li2-d2- | 30.57 | | 73.5 | 0.7989 | | | 26.39 | 33.61 | 0.79 | 0.05 | 16.43 |
| AA2 | | | | | | | | | | | |
| Td005-Li2-d2- | | | 29.0 | 0.1429 | 1.5065 | 91 | 349.51 | 90.72 | 3.85 | 0.62 | 7.11 |
| AA2-68 | | | | | | | | | | | |
| C-Td005-Li2-d2- | 17.26 | | 67.5 | 0.2613 | 2.0382 | 87 | 158.77 | 46.31 | 3.43 | 0.43 | 13.52 |
| AA2-68 | | | | | | | | | | | |
| Td0085-Li2-d2 | | | 24.6 | 0.1824 | 1.2455 | 85 | 477.80 | 47.05 | 10.16 | 3.09 | 22.95 |
| C-Td0085-Li2-d2 | 28.23 | | 60.6 | 0.3683 | 1.9846 | 81 | 277.21 | 40.27 | 6.88 | 0.73 | 10.85 |
| Td01-Li2-d2- | | | 18.2 | 0.1561 | 1.4829 | 89 | 472.58 | 31.31 | 15.09 | 1.42 | 10.65 |
| AA3.43 | | | | | | | | | | | |
| C-Td01-Li2-d2- | 45.03 | | 54.6 | 0.3792 | 1.7304 | 78 | 292.33 | 45.23 | 6.46 | 1.61 | 20.62 |
| AA3.43 | | | | | | | | | | | |
| BEADS | | | | | | | | | | | |
| PAA-beads- | | 1.65 | | 0.2617 | 1.3640 | 80.8 | 306.73 | 44.68 | 6.86 | 2.34 | 27.32 |
| Td005-Li2-d4 | | | | | | | | | | | |
| C-PAA-beads- | 41.94 | 1.21 | 26.7 | 0.2160 | 1.9924 | 89.2 | 38.52 | 94.82 | 4.02 | 3.38 | 26.82 |
| Td005-Li2-d4 | | | | | | | | | | | |

TABLE 3
Elemental analysis data for aerogels of Examples 1-3.

| | C | H | N | O | Li |
|---|---|---|---|---|---|
| sample | (%, w/w) | (%, w/w) | (%, w/w) | (%, w/w) | (%, w/w) |
| MONOLITHS | | | | | |
| Td005-Li2-d4 | 52.67 | 4.10 | 7.40 | 32.52 | 1.52 |
| C-Td005-Li2-d4 | 77.81 | 1.19 | 3.54 | 11.72 | 1.45 |
| Td01-Li2-d2-AA3.43 | 53.33 | 3.89 | 7.75 | 29.94 | 1.48 |
| C-Td01-Li2-d2- | 76.2 | 1.18 | 5.07 | 11.36 | 1.81 |
| AA3.43 | | | | | |
| BEADS | | | | | |
| PAA-beads-Td005- | 54.19 | 3.87 | 8.10 | 29.58 | 0.02 |
| Li2-d4 | | | | | |
| C-PAA-beads-Td005- | 83.31 | 0.98 | 7.34 | 4.63 | 0.05 |
| Li2-d4 | | | | | |

### Example 4. Polyimide Aerogels in Water at Td 0.05 g/cc Using NaHCO₃ as the Base and Pyrolysis to the Corresponding Carbon Aerogels

p-Phenylenediamine (3.315 g, 0.03065 mol) was dissolved in 200 mL of deionized water. Sodium bicarbonate (5.666 g, 2.2 mol excess) was added and dissolved in the same aqueous solution. Pyromellitic dianhydride (6.685 g, 0.03065 mol) was suspended in the same solution. A few minutes later, no solids were remaining in suspension. At the initial stages of the reaction gas evolution (CO₂) was observed. The viscous yellow solution was stirred for 3 days. Aliquots were taken every 24 hours and the viscosity of the aliquots measured with a rheometer. The values were: Day 1: 43.2 cP; Day 2: 44.7 cP; and Day 3: 44.8 cP. On the fourth day, 50 g of the viscous solution was separated out and to this portion was added a 4.3 mol excess of acetic anhydride relative to the monomer repeat unit contained in that amount (amount of acetic anhydride: 3.120 g). The resulting solution was stirred for about 30 seconds then divided into molds. The solution gelled in about 1 minute. The gels were transparent, light brown and rubbery, comparable to gels obtained in organic solvents by the classic routes. The gels were aged in their molds for 24 hours, then washed with ethanol (4 times) and dried with supercritical fluid CO₂.

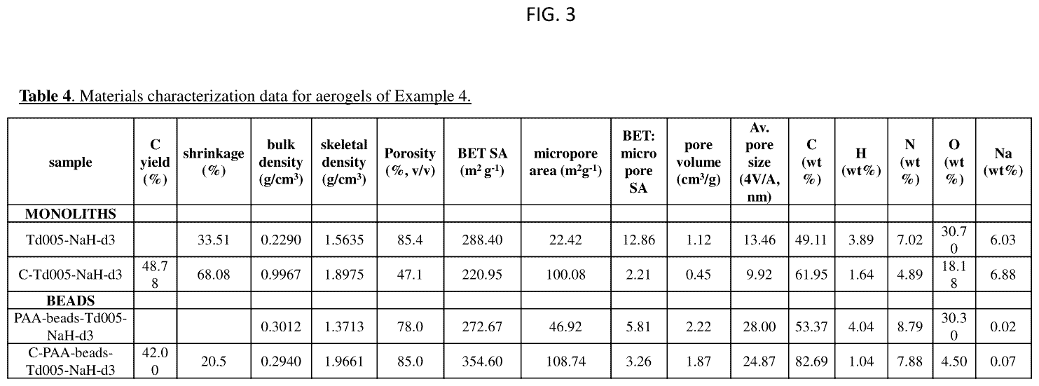

The remaining viscous yellow solution from Day 3 was dripped into an aqueous hydrochloric acid solution (30% concentrated HCl in deionized water). Beads formed instantly. The beads were aged in the receiving HCl solution for 24 hours, then washed with water (4 times, 12 hours each time, using 1 L of water each time). The beads were then similarly washed with ethanol before being dried with supercritical fluid CO₂. Materials characterization data for both Td005-NaH-d3 and C-Td005-NaH-d3, monoliths and beads, are provided in FIG. 3 (Table 4).

### Example 5. Polyimide Aerogels in Water at Td of 0.05 g/cc Using Ammonium Carbonate as the Base and Pyrolysis to the Corresponding Carbon Aerogels

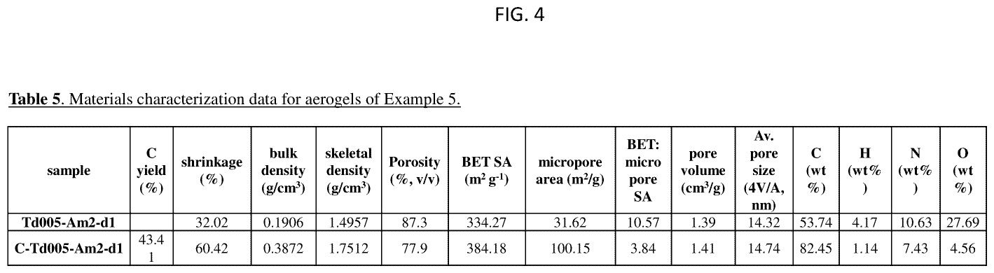

p-Phenylenediamine (3.315 g, 0.03065 mol) was dissolved in 200 mL of deionized water. Ammonium carbonate (3.535 g, 1.2 mol excess) was added and dissolved in the same aqueous solution. Pyromellitic dianhydride (6.685 g, 0.03065 mol) was suspended in the same solution. A few minutes later, no solids were remaining in suspension. At the initial stages of the reaction gas evolution (CO₂) was observed. The viscous yellowish solution was stirred for 1 day. The viscosity was measured with a rheometer. The value was: 205 cP. Then, a 4.3 mol excess of acetic anhydride relative to the monomer repeat unit was added in the solution (amount of acetic anhydride: 13.563 g). The new solution after the addition of acetic anhydride was stirred for about 30 sec and then it was divided into molds. The solution gelled in about 1 minute. The gels were transparent, light brown and rubbery, like gels obtained in organic solvents by the classic routes. Gels were aged in their molds at room temperature for 24 hours. Subsequently, they were washed with ethanol (4 times) and were dried with supercritical fluid CO₂ to obtain the corresponding monolithic polyimide aerogels. These aerogel monoliths are referred to as Td005-Am2-d1. Selected monoliths were pyrolyzed at 1050° C. under flowing nitrogen into the corresponding carbon aerogels, designated as C-Td005-Am2-d1. Materials characterization data for both Td005-Am2-d1 and C-Td005-Am2-d1 are provided in FIG. 4 (Table 5).

### Example 6. Polyimide Aerogels in Water at Target Density 0.05 g/cc Using Guanidinium Carbonate as the Base and Pyrolysis to the Corresponding Carbon Aerogels

p-Phenylenediamine (PDA; 3.32 g, 0.0307 mol) was dissolved in 200 mL of deionized water. Guanidinium carbonate (6.63 g, 1.2 mol excess) was added and dissolved in the aqueous PDA solution. Pyromellitic dianhydride (PMDA; 6.69 g, 0.0307 mol) was suspended in the solution. Gas evolution (CO₂) was observed during the initial stage of the reaction. No solid PMDA remained in suspension within minutes of the addition. The solution became viscous quickly (within a few minutes). The viscous solution was divided into two portions and processed into gels at either 2 or 3 hours after the initiation of the reaction by addition of acetic anhydride (13.48 g, 4.3 mol excess relative to the monomer repeat unit) to the solution. After the addition of the acetic anhydride, the solutions were stirred briefly and observed to gel within seconds. The resulting monolithic gels were yellow and opaque. The monolithic gels were aged at either room temperature (25° C.) or at 68° C. for 24 h, divided in smaller chunks, washed with ethanol 4 times, and dried with supercritical fluid CO₂ to obtain the corresponding monolithic aerogels having a foam appearance. These aerogel monoliths were titled Td005-G2-1.2-2_hours and Td005-G2-1.2-3_hours, depending on whether gelation with acetic anhydride was induced 2 h or 3 h after initiation of the reaction, respectively.

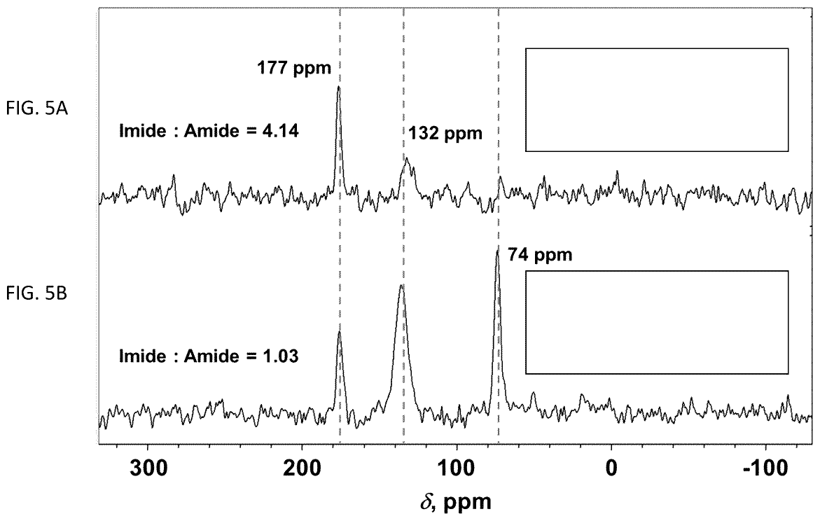

Another set of aerogel monoliths, titled Td005-G2-1.0-2_hours and Td005-G2-1.0-3_hours, were identically prepared with the exception that only 1 equivalent of guanidinium carbonate to monomer was utilized. Samples of the aerogel monoliths prepared using one equivalent of guanidinium carbonate, and aged at either room temperature (25° C.) or at 68° C. for 24 h, were analyzed by solid-state ¹⁵N NMR. FIG. 5A and FIG. 5B are overlayed solid-state ¹⁵N NMR spectrum of the organogel aerogels obtained with elevated temperature and room temperature aging, respectively. With reference to FIG. 5A, aging at 68° C. promoted imidization (larger peak at 177 ppm), while the spectrum of FIG. 5B indicates that aging at room temperature resulted in more amide (132 ppm) than imide groups. Further, with continued reference to FIG. 5B, with room temperature aging, the sample contained residual polyamate guanidinium salt as indicated by the guanidinium cation resonance at 74 ppm.

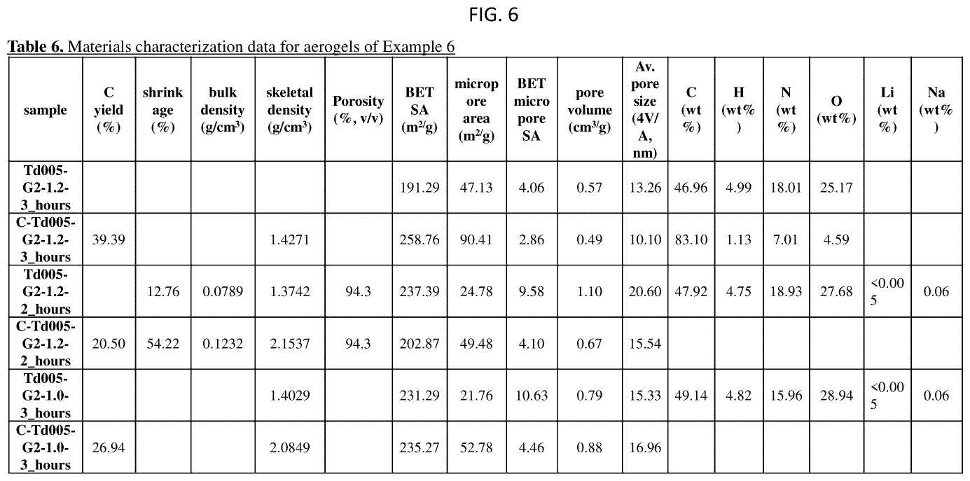

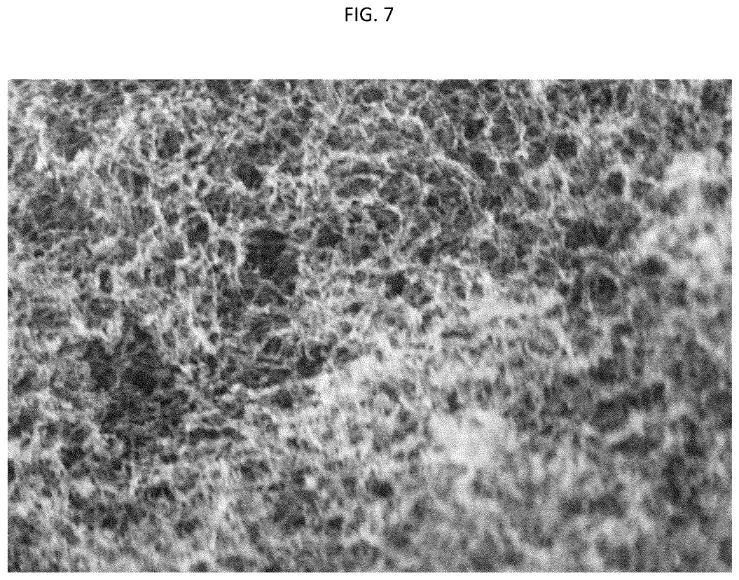

Selected monoliths were pyrolyzed at 1050° C. under flowing nitrogen into the corresponding carbon aerogels, designated with the prefix C. Materials characterization data are provided in FIG. 6 (Table 6), and FIG. 7 is an SEM photomicrograph of a carbonized sample. With reference to FIG. 7, at high magnification (50,000×) the walls of the larger pores that provide the foamy appearance consist of entangled nanofibers.

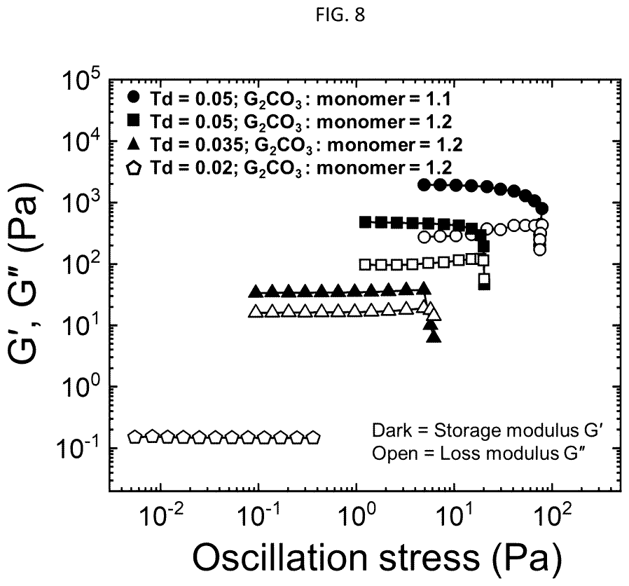

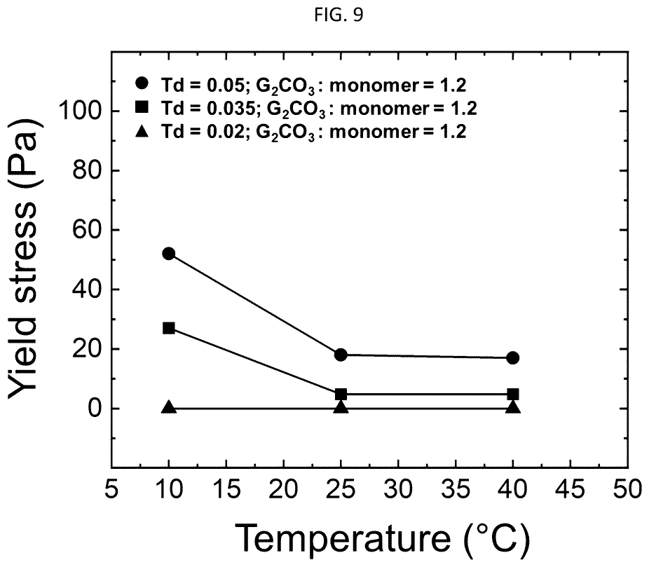

A similar solution of PDA+PMDA polyamic acid guanidinium salt (Td=0.05) was left reacting for 24 hours. At that point, the solution (referred to as Td005-G2-1.0-24_hours) became so viscous that it stopped flowing. However, it flowed when agitated (stirred). To further study this phenomenon, solutions of PDA+PMDA polyamic acid guanidinium salt with different amounts of guanidinium carbonate and at different target densities were similarly prepared. The linear viscoelastic response of the polyamate solutions was measured using rheometry with a cone (60 mm diameter 2° slope) and plate geometry on a temperature-controlled Peltier plate (FIG. 8). Specifically, FIG. 8 is a graphical depiction of oscillation stress versus storage modulus and loss modulus for oscillatory amplitude sweeps of guanidinium polyamate solutions at different target densities (Td, where Td refers to the total solid (PDA+PMDA) concentration (g/cm³) in the sol) prepared from guanidinium carbonate at various ratios of carbonate to PDA (monomer). With reference to FIG. 8, in the oscillation mode and at low shear stresses, some guanidinium polyamate solutions display solid-like behavior (G′>G″) including a storage modulus (G′) independent of oscillation stress, and a loss modulus (G″). However, above a critical stress, referred to as the yield stress, the storage modulus G′ drops precipitously and the system flows. Decreasing the guanidinium polyamate concentration resulted in lower plateau modulus and a lower yield stress as the polymer network becomes more disperse. With continued reference to FIG. 8, at sufficiently low polymer concentration for the solution with 2% solids content (Td=0.02), the polymer solution no longer forms a percolated gel and flows at all observed stresses. Furthermore, some solutions with guanidinium polyamate concentrations slightly above the critical gel concentration have been observed to not gel when the polymer was limited to lower molecular weight. In addition to the guanidinium polyamate concentration, the yield stress is also sensitive to temperature where a lower temperature requires a higher critical stress to initiate flow, as shown in FIG. 9.

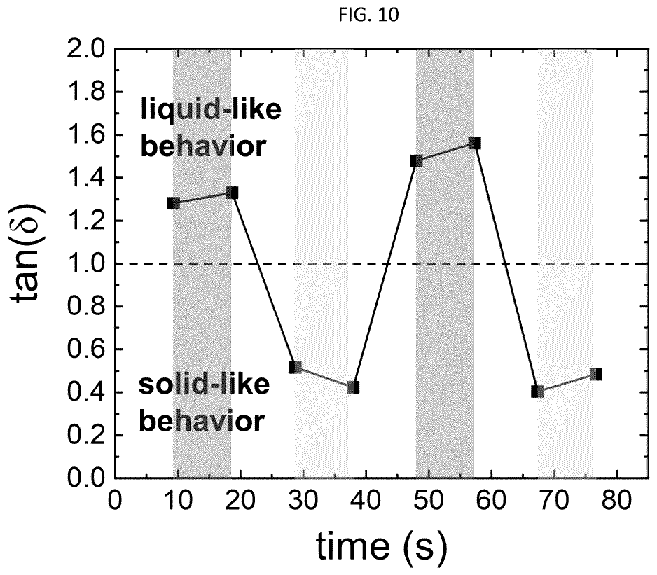

Upon termination of the experiment, the solution quickly regained the solid behavior. Cycling shear amplitude values below then above the yield stress displays quick reproduceable switching from solid (tan(δ)<1) to liquid-like (tan(δ)>1) viscoelastic response, as shown in FIG. 10, where tan(δ) is the ratio G″/G′. With reference to FIG. 10, for the guanidinium polyamate solution (Td=0.05; monomer to guanidinium carbonate ratio of 1:2), the material undergoes shear thinning with increasing shear rate (thixotropy).

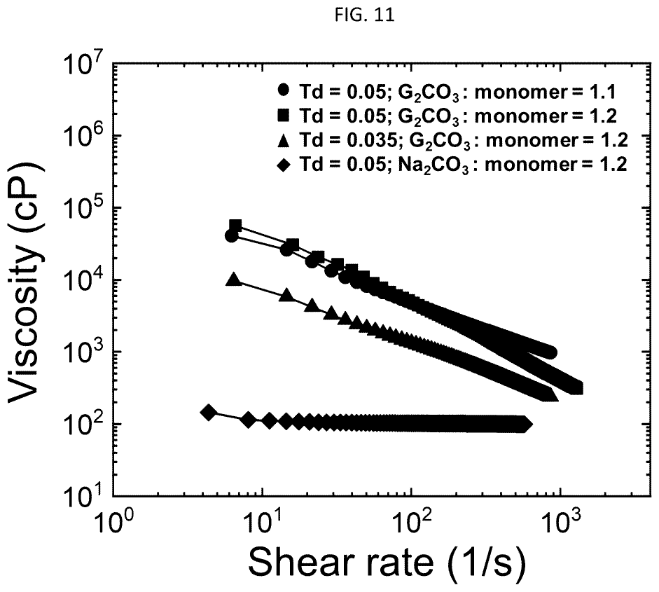

FIG. 11 is a graphical depiction of shear rate versus viscosity for steady-state rotational sweeps for various aqueous polyamate solutions. With reference to FIG. 11, a decrease in viscosity (shear thinning) with increasing shear rate for guanidinium carbonate based polyamate solutions was observed (thixotropy). With continued reference to FIG. 11, for an aqueous polyamate solution formed with the monovalent metal cation Na⁺ (Na₂CO₃ at Td=0.05), thixotropic behavior is not observed. Other monovalent metal cations such Li⁺, K⁺, and ammonium also did not result in thixotropic behavior of the corresponding polyamate solutions (data not shown). Gels formed by exposing the polyamate solution to a solution containing multivalent cations did not display a thixotropic viscoelastic response either; they rather formed gels data not shown. In this regard, without wishing to be bound by theory, it is believed that the thixotropic behavior requires a cation capable of dynamically interacting (e.g., via hydrogen bonding) with multiple polymer chains (e.g., guanidinium).

### Example 7. Polyimide Aerogels in Water Using Other Water-Soluble Carbonate Salts as Bases

Other common water-soluble carbonate salts not included in the specific Examples above include lithium bicarbonate (LiHCO₃), sodium carbonate (Na₂CO₃), potassium carbonate (K₂CO₃), potassium bicarbonate (KHCO₃), and ammonium bicarbonate (NH₄HCO₃). Each of these formed aqueous polyamate solutions according to the procedures of the foregoing Examples.

### Example 8. Molecular Weight Determinations of Polyamic Acid Salts Produced with Sodium Carbonate as Base

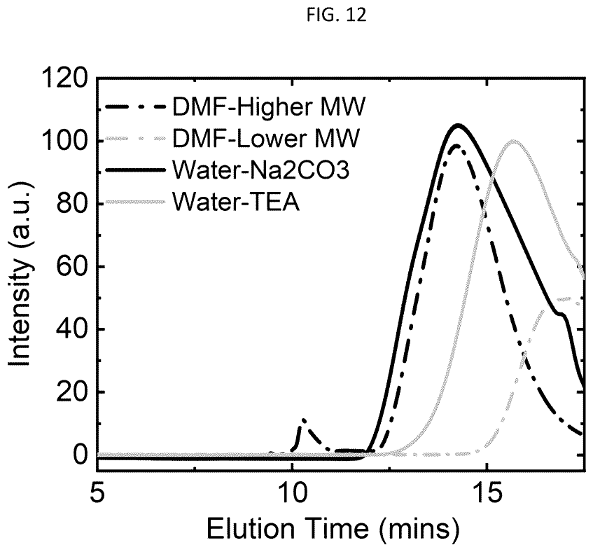

Polyamic acid sodium salt solutions were prepared using sodium carbonate as the base according to the foregoing examples (i.e., from PDA-PMDA in aqueous solution). Reference polyamate salt solutions were prepared using the conventional process (dimethyl formamide as solvent, triethylamine as base, prior to precipitation and washing with acetone) as well as a previous aqueous process (water as solvent, triethylamine as the base). The precipitated polymer was dissolved into a water and Na₂CO₃ solution (5% solids PAA with 1.2 mol equivalents Na₂CO₃:monomer). The reference and inventive polyamate solutions were analyzed for the molecular weight of the polyamic acid polymers by gel permeation chromatography (GPC) using as molecular weight standards previously polyamate salts having known molecular weights (FIG. 12). The polyamic acids were eluted in water with 0.2M Na₂SO₄, and the molecular weights calculated from the peak elution time using polyamic acid polymers with previously measured molecular weight. With reference to FIG. 12, the product of the disclosed carbonate/water process (solid black line) showed earlier elution time (higher molecular weight) relative to the reference TEA water-process (solid gray line) and overlapping molecular weight peak distribution with the higher MW sample prepared in DMF according to the conventional method (dotted black line). Generally, the GPC results showed that the molecular weight peak and distribution were comparable for products of the solvent-based conventional method and the disclosed inventive carbonate base method, with a molecular weight peak for products from both methods of around 20,000 to 30,000 g/mol. In contrast, the GPC result for the product of the previous aqueous process (water as solvent, triethylamine as the base) indicated much lower product molecular weight (2,000-8,000 g/mol).

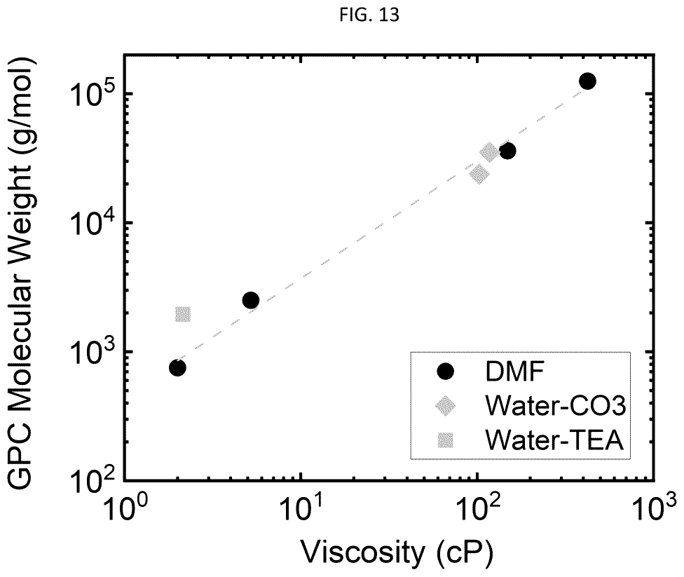

Rheological analysis of the solutions was performed (viscosity determination; measured with continuous flow at 1 rad/s). Specifically, the viscosity of the three polyamate sodium salt solutions described above (conventional DMF method, redissolved; previous water-TEA method; and disclosed water-carbonate method) was determined and plotted against the molecular weight of each as determined by GPC (FIG. 13). With reference to FIG. 13, viscosity of equivalent solutions (same polymer concentration and same Na₂CO₃ concentration) showed a power-law relationship and confirmed the GPC analysis results.

What is claimed is:

1. A method of preparing a polyimide aerogel, the method comprising:
combining in water a water-soluble diamine, a water-soluble carbonate or bicarbonate salt, and a tetracarboxylic acid dianhydride;
allowing the components to react, providing an aqueous solution of a salt of a polyamic acid;
imidizing the polyamic acid salt to form a polyimide wet gel, wherein imidizing the polyamic acid salt comprises adding a gelation initiator to the aqueous solution of the polyamic acid salt to form a gelation mixture and allowing the gelation mixture to gel; and
drying the polyimide wet gel to form the polyimide aerogel.

2. The method of claim 1, wherein the combining comprises:
dissolving a water-soluble diamine in water to form an aqueous diamine solution;
adding the water-soluble carbonate or bicarbonate salt to the aqueous diamine solution;
adding a tetracarboxylic acid dianhydride to the aqueous solution of the diamine and the water-soluble carbonate or bicarbonate salt to form a solution; and
stirring the solution for a period of time in a range from about 1 hour to about 4 days at a temperature in a range from about 4 to about 60° C.

3. The method of claim 1, wherein the combining comprises:
dissolving a water-soluble diamine in water to form an aqueous diamine solution;
adding a tetracarboxylic acid dianhydride to the aqueous diamine solution to form a suspension;
stirring the suspension for a period of time in a range from about 1 hour to about 4 days at a temperature in a range from about 4 to about 60° C.;
adding the water-soluble carbonate or bicarbonate salt to the suspension; and
stirring the suspension for a period of time in a range from about 1 hour to about 4 days at a temperature in a range from about 4 to about 60° C. to provide the aqueous solution of the salt of the polyamic acid.

4. The method of claim 1, wherein the combining comprises:
adding to water, simultaneously or in rapid succession, a water-soluble diamine, a tetracarboxylic acid dianhydride, and the water-soluble carbonate or bicarbonate salt; and
stirring the resulting mixture for a period of time in a range from about 1 hour to about 4 days at a temperature in a range from about 4 to about 60° C. to provide the aqueous solution of the polyamic acid salt.

5. The method of claim 1, wherein the water-soluble carbonate or bicarbonate salt comprises lithium, sodium, potassium, ammonium, or guanidinium cations.

6. The method of claim 1, wherein the water-soluble carbonate or bicarbonate salt is selected from the group consisting of lithium carbonate, lithium bicarbonate, sodium carbonate, sodium bicarbonate, potassium carbonate, potassium bicarbonate, ammonium carbonate, ammonium bicarbonate, guanidinium carbonate, and combinations thereof.

7. The method of claim 1, wherein:
the water-soluble carbonate or bicarbonate salt is a carbonate, and a molar ratio of the water-soluble carbonate salt to the diamine is from about 1 to about 1.4; or
the water-soluble carbonate or bicarbonate salt is a bicarbonate, and a molar ratio of the water-soluble bicarbonate salt to the diamine is from about 2 to about 2.8.

8. The method of claim 1, wherein a molar ratio of the tetracarboxylic acid dianhydride to the diamine is from about 0.9 to about 1.1.

9. The method of claim 1, wherein the tetracarboxylic acid dianhydride is selected from the group consisting of biphthalic dianhydride (BPDA), benzophenone tetracarboxylic dianhydride (BTDA), oxydiphthalic dianhydride (ODPA), napthanyl tetracarboxylic dianhydride, perylene tetracarboxylic dianhydride, and pyromellitic dianhydride (PMDA).

10. The method of claim 1, wherein the diamine is 1,3-phenylenediamine, 1,4-phenylenediamine, or a combination thereof.

11. The method of claim 1, wherein the diamine is 1,4-phenylenediamine.

12. The method of claim 1, wherein a range of concentration of the polyamic acid salt in the aqueous solution is from about 0.01 to about 0.3 g/cm³, based on the weight of the polyamic acid.

13. The method of claim 1, wherein the water-soluble carbonate or bicarbonate salt is guanidinium carbonate, and wherein the solution of the salt of the polyamic acid exhibits thixotropic behavior.

14. The method of claim 1, further comprising adding an electroactive material to the aqueous solution of the polyamic acid salt.

15. The method of claim 14, wherein the electroactive material comprises carbon, graphite, silicon, sulfur, Prussian blue, lithium iron phosphate, a combination thereof, or a one or more precursors of any thereof.

16. The method of claim 1, wherein the gelation initiator is acetic anhydride.

17. The method of claim 1, wherein drying the polyimide wet gel comprises:
optionally, washing or solvent exchanging the polyimide wet gel; and
subjecting the polyimide wet gel to elevated temperature conditions, lyophilizing the polyimide wet gel, or contacting the polyimide wet gel with supercritical fluid carbon dioxide.

18. The method of claim 1, further comprising converting the polyimide aerogel to an isomorphic carbon aerogel, the converting comprising pyrolyzing the polyimide aerogel under inert atmosphere at a temperature of at least about 650° C.

19. A polyimide aerogel prepared by the method of claim 1, the polyimide aerogel comprising a residual amount of the water-soluble carbonate or bicarbonate salt.

20. A carbon aerogel prepared by the method of claim 18.
